(19) United States
(12) Patent Application Publication
(10) Pub. No.: US 2017/0329351 A1
(43) Pub. Date: Nov. 16, 2017

(54) APPARATUS-ASSISTED SENSOR DATA COLLECTION

(71) Applicant: QUALCOMM Incorporated, San Diego, CA (US)

(72) Inventors: Edwin Chongwoo Park, San Diego, CA (US); Yih-Hao Lin, San Diego, CA (US); Samir Soliman, Poway, CA (US); Bala Ramasamy, San Diego, CA (US)

(21) Appl. No.: 15/594,456

(22) Filed: May 12, 2017

Related U.S. Application Data
(63) Continuation-in-part of application No. 14/720,492, filed on May 22, 2015.

(51) Int. Cl. G05D 1/10; B64C 39/02; G01S 5/02; H01Q 3/08; H01Q 1/28

(52) U.S. Cl. CPC G05D 1/101; B64C 39/024; G01S 5/0205; B64C 2201/108; B64C 2201/027; H01Q 1/28; H01Q 3/08; B64C 2201/127

(57) ABSTRACT

The disclosure provides various methods and apparatus useful for mapping wireless nodes using a drone and aligning the body of the drone with an antenna of the wireless node. A method includes mapping, by an apparatus, a space including one or more locations of one or more wireless nodes, determining whether the apparatus is in proximity to a first wireless node of the one or more wireless nodes, determining an orientation of an antenna of the first wireless node, and in response to determining that the apparatus is in proximity to the first wireless node and determining the orientation of the antenna of the first wireless node, adjusting a six-degree-of-freedom (6DoF) orientation of the apparatus based on the determined orientation of the antenna of the first wireless node. The apparatus may be an autonomous drone.

### PRIORITY CLAIM

This application is a continuation-in-part of, and claims priority to and the benefit of co-pending nonprovisional patent application Ser. No. 14/720,492, filed in the United States patent office on May 22, 2015, entitled “Apparatus-Assisted Data Collection,” which is assigned to the assignee hereof and incorporated herein by reference in its entirety.

### TECHNICAL FIELD

The present disclosure relates generally to locating wireless nodes and, more particularly, to apparatus-assisted powering of, and data collection from, a wireless node.

### BACKGROUND

Conventional systems for measuring environmental conditions may utilize various sensors. For example, sensors may measure temperature, moisture, radioactivity, luminosity, pressure, etc. In some applications, these sensors may be deployed throughout a large geographic area (e.g., tens or hundreds of acres). Some conventional systems may utilize wires for providing power to the sensors and for receiving data from the sensors. However, deploying such a system across a large geographic area may involve substantial material costs and/or labor demands for maintenance and repair. Other conventional systems may utilize wireless nodes having batteries to provide power to the wireless node and/or sensor(s) associated with the wireless node. Batteries sometimes need to be replaced and have the potential to leak or corrode. Some other conventional systems may utilize solar cells to provide power to the wireless node and/or sensor(s) associated with the wireless node. Solar cells may receive limited sunlight during cloudy, rainy, or snowy days. Accordingly, conventional systems can benefit from improvements that enhance power supply to and data collection from a wireless node and/or sensor(s) associated with the wireless node.

### BRIEF SUMMARY OF SOME EMBODIMENTS

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In an aspect, the present disclosure provides a method operational by an apparatus (e.g., a drone). The method includes mapping, by the apparatus, a space including one or more locations of one or more wireless nodes. The method further includes determining whether the apparatus is in proximity to a first wireless node of the one or more wireless nodes and determining an orientation of an antenna of the first wireless node. The method still further includes, in response to determining that the apparatus is in proximity to the first wireless node and determining the orientation of the antenna of the first wireless node, adjusting a six-degree-of-freedom (6DoF) orientation of the apparatus based on the determined orientation of the antenna of the first wireless node.

In another aspect, the present disclosure provides an drone. The drone includes a transceiver, a memory, and at least one processor communicatively coupled to the transceiver and the memory. The at least one processor is configured to map a space including one or more locations of one or more wireless nodes. The at least one processor is further configured to determine whether the drone is in proximity to a first wireless node of the one or more wireless nodes and determine an orientation of an antenna of the first wireless node. The at least one processor is further configured to, in response to determining that the drone is in proximity to the first wireless node and determining the orientation of the antenna of the first wireless node, adjust a six-degree-of-freedom (6DoF) orientation of the drone based on the determined orientation of the antenna of the first wireless node.

In a further aspect, the present disclosure provides yet another drone. The drone includes means for mapping, by the drone, a space including one or more locations of one or more wireless nodes. The drone further includes means for determining whether the drone is in proximity to a first wireless node of the one or more wireless nodes and means for determining an orientation of an antenna of the first wireless node. The drone still further includes means for, in response to determining that the drone is in proximity to the first wireless node and determining the orientation of the antenna of the first wireless node, adjusting a six-degree-of-freedom (6DoF) orientation of the drone based on the determined orientation of the antenna of the first wireless node.

These and other aspects of the disclosure will become more fully understood upon a review of the detailed description, which follows. Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating a first example of an apparatus moving to a position in proximity to a point of interest (POI).

FIG. 2 is a diagram illustrating a first example of an apparatus with an extension portion extending towards the POI.

FIG. 3 is a diagram illustrating a first example of an apparatus with an extension portion retracting away from the POI.

FIG. 4 is a diagram illustrating a second example of an apparatus moving to a position in proximity to POI.

FIG. 5 is a diagram illustrating a second example of an apparatus with an extension portion extending towards the POI.

FIG. 6 is a diagram illustrating a second example of an apparatus with an extension portion retracting away from the POI.

FIG. 7 is a diagram illustrating an example of various methods and/or processes operable at an apparatus.

FIG. 8 is a diagram illustrating an example of an apparatus mapping a space including one or more locations of one or more wireless nodes.

FIG. 9 is a diagram illustrating an example of the apparatus of FIG. 8 hovering at a location in proximity to a mapped location of the first wireless node of one or more wireless nodes and determining an orientation of an antenna of the first wireless node with respect to an antenna of the apparatus.

FIG. 10 is a diagram illustrating an example of the apparatus of FIG. 8 aligning a boresight of an antenna of the apparatus with a boresight of an antenna of the first wireless node.

FIG. 11 is a diagram illustrating an example of the apparatus of FIG. 8 hovering at a location in proximity to a mapped location of a second wireless node of one or more wireless nodes and determining an orientation of an antenna of the second wireless node with respect to an antenna of the apparatus.

FIG. 12 is a diagram illustrating an example of the apparatus of FIG. 8 aligning a boresight of an antenna of the apparatus with a boresight of an antenna of the second wireless node.

FIG. 13 is a diagram illustrating an example of the apparatus of FIG. 8 aligning a boresight of an antenna of the apparatus with a boresight of an antenna of the second wireless node.

FIG. 14 is a diagram illustrating an example of the apparatus of FIG. 8 aligning a boresight of an antenna of the apparatus as close as possible with a boresight of an antenna of the wireless node.

FIG. 15 is a diagram illustrating an example of various methods and/or processes operable at an apparatus.

FIG. 16 is a diagram illustrating an example of a hardware implementation of a processing system of an apparatus.

FIG. 17 is a logical device diagram illustrating an example of an interface between a processor and subsystems of an apparatus.

### DETAILED DESCRIPTION OF SOME EMBODIMENTS

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

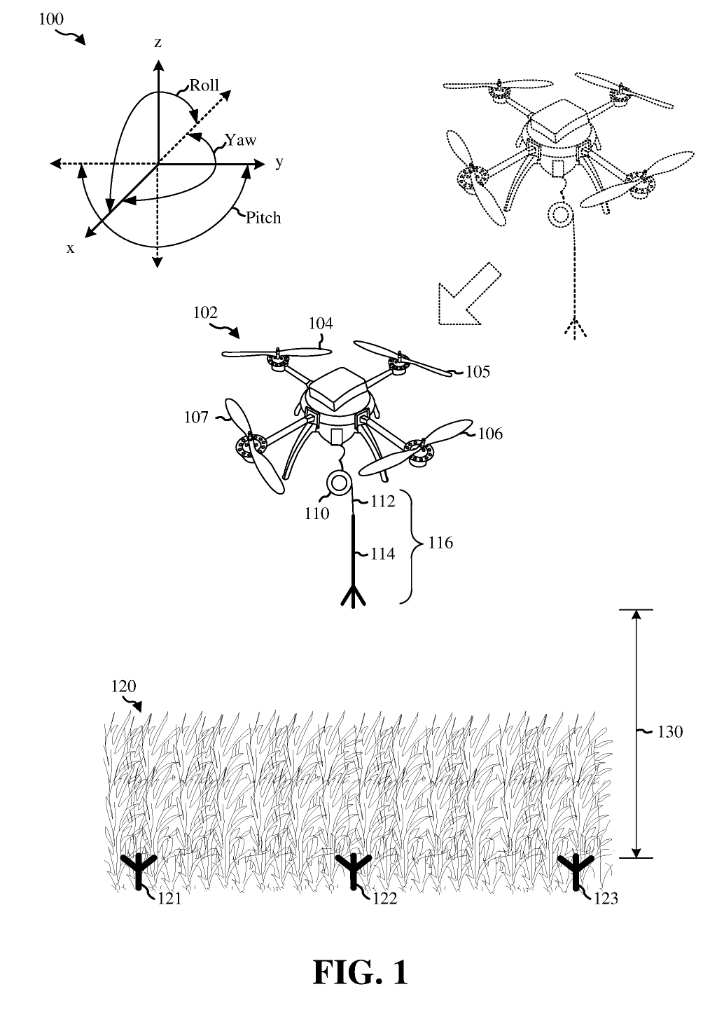

FIG. 1 is a diagram 100 illustrating an example of an apparatus 102 moving to a position in proximity to a point of interest (POI). As used herein, the apparatus 102 may be represented by a drone, which may be a multi-propeller aerial vehicle. As used herein, a multi-propeller aerial vehicle (the drone) may be an aerial vehicle having a plurality of motorized propellers. For horizontal and vertical flight, the propellers may all generally point in the same direction. Furthermore, the drone may be autonomous or semi-autonomous. The term ‘POI’ may refer to a specific point, region, location, and/or geography. The POI may be identified or defined using various parameters without deviating from the scope of the present disclosure. For example, the POI may be identified or defined by a longitude and latitude coordinate, an elevation or altitude coordinate, an address, a beacon, a sensor, a wireless node, a stationary target, a fixed location, an anchored object, a moving target, a changing location, a mobile object, and/or various other suitable references. Such parameters may be utilized by various positioning and/or geolocation technologies without deviating from the scope of the present location. For example, such parameters may be utilized by a Global Positioning System (GPS), a Global Information System (GIS), a satellite system, a signal triangulation system, an inertial navigation unit, a real time kinematic (RTK) unit, and/or various other suitable positioning and/or geolocation systems. In some configurations, the POI may correspond to the location of an object. One of ordinary skill in the art will understand that the POI may correspond to any object without deviating from the scope of the present disclosure. As a non-limiting example, FIG. 1 illustrates that the POI corresponds to the location of a wireless node 122. In some implementations, the wireless node 122 may be a generic device with no sensing capabilities. For example, the wireless node 122 may be a remote base station with a battery, and the apparatus 102 (e.g., drone) may be present to charge the battery so a user does not have to physically go to the location of the wireless node 122. In some implementations, however, the wireless node 122 may include a sensor.

The apparatus 102 may be any device that is configured to move to a position that is in proximity to an object (e.g., the wireless node 122). Movement of the apparatus 102 may be powered by various types of actuators without deviating from the scope of the present disclosure. For example, the apparatus 102 may utilize a hydraulic actuator, a pneumatic actuator, an electric actuator, a thermal actuator, a magnetic actuator, a mechanical actuator, and/or any other suitable type of actuator. An apparatus 102 may be characterized as a drone if the apparatus 102 is configured to move or navigate without continuous human control. Additionally or alternatively, the apparatus 102 may be characterized as a drone if the apparatus 102 is an unmanned apparatus, an unpiloted apparatus, a remotely-piloted apparatus, or any other apparatus that does not have a pilot on board. For purposes of illustration and not limitation, FIG. 1 shows that such an apparatus 102 may be an aerial drone. Generally, an aerial drone is a drone that is configured to move in the air for at least a period of time. An aerial drone may be a multi-propeller apparatus. That is, it may have a plurality of motorized propellers. The apparatus 102 of FIG. 1 is illustrated as having four propellers and may be referred to as a quadcopter. However, one of ordinary skill in the art will understand that the apparatus 102 may have any number of propellers without deviating from the scope of the present disclosure. According to some aspects of the disclosure, the aerial drone may be configured to tilt or rotate about one or more axes (e.g., rotation about the X, Y, and/or Z axes, sometimes referred to as yaw, pitch, and roll about a normal axis, a lateral axis, and/or a longitudinal axis, respectively). According to further aspects of the disclosure, the aerial drone may be configured to move in a direction along one or more of the axes (e.g., translation in the direction of the X, Y, and/or Z axes). In this manner, that the body of the apparatus 102 may be oriented with up to six degrees of freedom (e.g., translation in the X, Y, and Z directions, plus rotation in roll, yaw and pitch directions). According to still some other aspects of the disclosure, the propellers of the aerial drone may be configured to tilt with respect to the body of the apparatus 102, such that the propellers of the apparatus 102 remain horizontal while the body of the apparatus may be oriented with up to six degrees of freedom. According to still some other aspects of the disclosure, when the apparatus 102 has six or more propellers, or eight or more propellers, the propellers may be fixed (i.e., non-tilting with respect to the body of the apparatus 102) and the apparatus 102 may be configured to hover at a given location while the body of the apparatus 102 may still be oriented with up to six degrees of freedom; that is, the entire apparatus 102 may be made to tilt in the yaw, pitch, and roll directions while maintaining a hover at a given location in space. However, one of ordinary skill in the art will understand that the apparatus 102 may be a non-aerial (e.g., terrestrial, amphibious, or aquatic) drone without deviating from the scope of the present disclosure.

In some configurations, the apparatus 102 may be a terrestrial drone. Generally, a drone may be characterized as terrestrial if the drone is configured to move while in contact with the ground. The terrestrial drone may sometimes be referred to as an unmanned ground vehicle. The terrestrial drone may move utilizing various mechanisms without deviating from the scope of the present disclosure. For example, the terrestrial drone may utilize wheels, rails, hydraulic components, and/or any other suitable type of feature to facilitate movement while in contact with the ground. The terrestrial drone may be configured to move to a position that is in proximity to the object (e.g., the wireless node 122) by moving towards that object (e.g., the wireless node 122) and positioning itself near that object (e.g., the wireless node 122). For example, the terrestrial drone may be configured to be sufficiently close to that object (e.g., the wireless node 122) such that its extension portion can reach that object (e.g., the wireless node 122).

In some configurations, the apparatus 102 may be an aquatic drone. Generally, a drone may be characterized as aquatic if the drone is configured to move while buoyant on water or at least partially submerged under water for at least a period of time. For example, the aquatic drone may be submersible under water (e.g., a submarine), a buoyant vessel (e.g., a boat, a raft, etc.), or any other apparatus configured to move while buoyant on water or at least partially submerged under water for at least a period of time. The aquatic drone may move utilizing propellers, rudders, and/or any other suitable mechanisms of navigating on and/or under water. The aquatic drone may be configured to move to a position that is in proximity to the object by moving towards that object and positioning itself near that object. For example, the aquatic drone may be configured to be sufficiently close to that object such that its extension portion can reach that object.

In some configurations, the apparatus 102 is an autonomous drone, which includes software and/or hardware modules that enables the apparatus 102 to control its own movements without relying upon constant control and navigation instructions from a user. Generally, a drone may be characterized as autonomous if the drone is configured to make one or more decisions utilizing the aforementioned software and/or hardware modules without direct input from a human. For example, an autonomous drone may be configured to locate the POI (e.g., the wireless node 122 and/or the location corresponding to the wireless node 122) and navigate itself such that it is positioned in proximity to that POI without necessarily being continually piloted by a human. For example, an autonomous drone may be configured to map a space including one or more locations of one or more wireless nodes (each of which may be located at a POI) and navigate itself such that it may determine whether it is positioned in proximity to a first wireless node of the one or more wireless nodes without necessarily being continually piloted by a human. By way of further example, the autonomous drone may be configured to map a space including one or more locations of one or more wireless nodes and establish a mapped location of a first wireless node of the one or more wireless nodes based on the mapping. The autonomous drone may hover at a location in proximity to the mapped location of the first wireless node. As used in this disclosure, the word “hover” may mean to float at a location or hang at a location or remain stationary at a location and may further mean to linger, wait, remain, and/or loiter at the location for a period of time.

In certain circumstances, the location of the POI may change from time to time. In some configurations, the apparatus 102 may update, adjust, revise, correct, refine, and/or otherwise calibrate the location of the POI. For example, the apparatus 102 may include various detection mechanisms (e.g., on-board sensors, etc.) that may enable the apparatus 102 to detect a change in the location of the POI. The apparatus 102 may update, adjust, revise, correct, refine, and/or otherwise calibrate the location of the POI from one data collection attempt (e.g., a first ‘run’) to another data collection attempt (e.g., a second ‘run’). Such detection mechanisms may utilize the power measurements of the wireless node 122, various triangulation technologies, optical recognition, laser scanning, simultaneous localization and mapping (SLAM), radio frequency angle of arrival, and/or other techniques for detecting a change in the location of the POI. In some circumstances, a wireless node 122 located on, underneath, above, or otherwise near the ground may move, shift, slide, and/or otherwise alter in location from time to time. As applied to non-limiting applications in agriculture, the wireless node 122 may shift, move, shift, slide, and/or otherwise alter in location as a result of various factors. Such factors may include: the growth of agricultural plants 120; movement caused by animals contacting the wireless node 122; movement of the soil or ground during fertilization, watering, harvesting, and/or other suitable activities; and/or various objects and/or machines contacting the wireless node 122. By updating, adjusting, revising, correcting, refining, and/or otherwise calibrating the location of the POI from one data collection attempt (e.g., a first ‘run’) to another data collection attempt (e.g., a second ‘run’), the apparatus 102 can navigate to a location that is relatively closer to the wireless node 122 even during changes in the environment affecting the location of the wireless node 122.

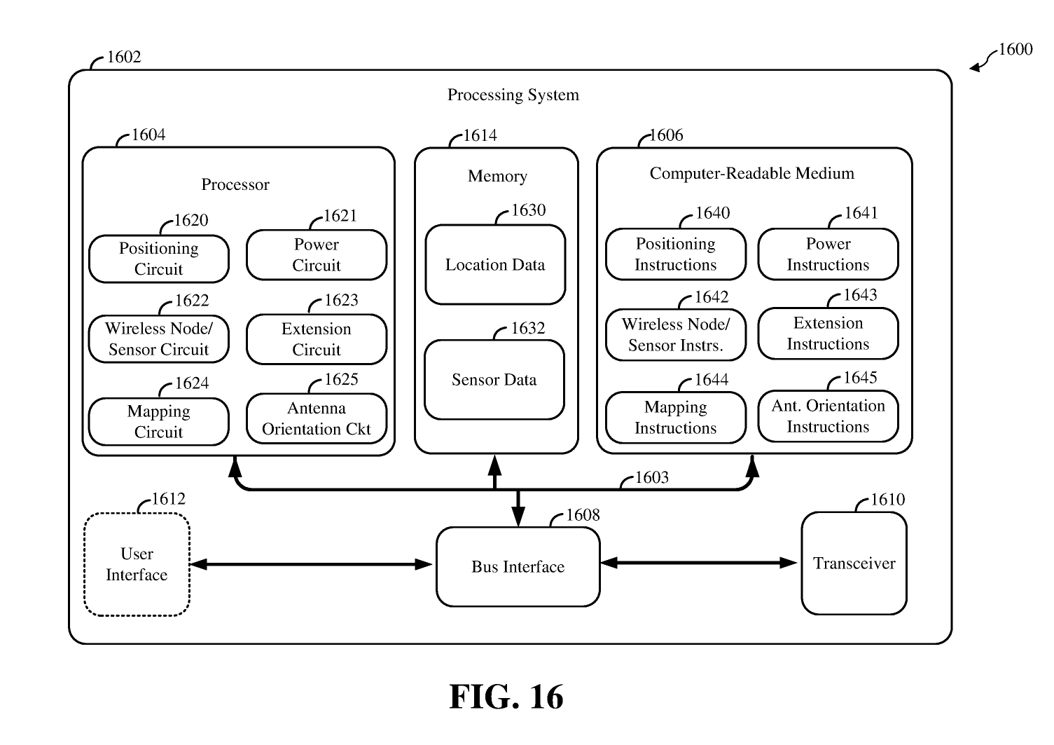

The apparatus 102 may include various components configured for moving the apparatus 102. The apparatus 102 may include a body that includes a processing system. In some configurations, the apparatus 102 includes a power source. Various examples of such power sources are described in greater detail below and therefore will not be repeated. In some other configuration, the power source may be separate from the apparatus. For example, the apparatus 102 may have a wired connection to a power source (e.g., an electric generator, etc.) that is otherwise detached from the apparatus 102. The processing system, which is further described below with reference to FIG. 16, may provide the means for processing various data (e.g., data received from one or more wireless nodes and/or sensors included in the wireless nodes). The power source may be a battery, a solar cell, an electric generator, a fuel cell, or any other suitable component that provides power. The power source may provide the means for powering the apparatus and/or means for powering one or more wireless nodes and/or sensors included in the wireless nodes to which the apparatus may couple. For purposes of illustration and not limitation, FIG. 1 shows an apparatus 102 that includes a number of propellers 104-107 that assist with the levitation and lateral movement of the apparatus 102. The apparatus 102 may include a plurality of motors, where each motor controls the movement of a respective propeller 104-107 and thus the apparatus 102. The motors may be mechanical, electric, or any other suitable type of motor. The motors may provide the means for positioning the apparatus in proximity to a POI. The propellers 104-107 may be individually varied in rotational speed and direction to control the direction of movement of the apparatus in the x-axis, the y-axis, and the z-axis as well as to control the direction of the apparatus in roll, pitch, and yaw. In some aspects of the disclosure, the propellers 104-107 may be angled (i.e., individually or collectively tilted) in different directions to control the direction of movement of the apparatus in the x-axis, the y-axis, and the z-axis as well as to control the direction of the apparatus in roll, pitch, and yaw. According to all aspects of the disclosure, the apparatus may be oriented with up to six degrees of freedom. The rotational speed of the propellers 104-107 may affect the degree to which the apparatus 102 ascends, hovers, and descends in the z-axis. One or more of the propellers 104-107 may also affect the yaw, pitch, and/or roll of the apparatus 102. However, one of ordinary skill in the art will understand that the apparatus 102 may include alternative and/or additional components for movement without deviating from the scope of the present disclosure. For example, the apparatus 102 may include a fixed-wing, wherein the fixed-wing may be configured to assist the apparatus 102 with gliding and turning in the air. As another example, the apparatus 102 may be terrestrial and include one of many types of motor engines, which may be powered by gasoline, diesel, bio-fuels, and/or electric power generated by a solar-based power generator and/or a wind-based power generator. One of ordinary skill in the art understands that that apparatus 102 may include various components configured for moving the apparatus 102 without deviating from the scope of the present disclosure.

The apparatus 102 may also include an extension portion 116. The extension portion 116 may exist in various forms, types, configurations, and arrangements without deviating from the scope of the present disclosure. Any description herein with regard to the extension portion 116 of the apparatus 102 is provided for illustrative purposes and shall not be construed excluding alternative forms, types, configurations, and arrangements of the extension portion 116 of the apparatus 102. Generally, the extension portion 116 is characterized as any portion of the apparatus 102 that at least in part extends at any time in any manner beyond the contour of another portion of the apparatus 102. As described in greater detail below, the extension portion 116 may be fixed in length, configuration, angle, direction, and/or other aspects in some configurations and may be adjustable in length, configuration, angle, direction, and/or other aspects in some other configurations. As also described in greater detail below, such ‘extending’ may refer to drawing out, unreeling, unfolding, folding out, angling outward, rotating outward, gliding outward, spiraling outward, unwinding, and/or otherwise moving at least a part of the extension portion 116 towards a particular area (e.g., the POI, such as the wireless node 122).

In the non-limiting example illustrated in FIG. 1, the extension portion 116 of the apparatus 102 includes an antenna 114 located at the distal part of a retractable transmission line 112. The retractable transmission line 112 may include a power line configured for providing power from the power source (as described above) of the apparatus 102 to a distal part (e.g., the antenna 114) of the extension portion 116. The retractable transmission line 112 may also include a communication line configured for communicating data from the distal part (e.g., the antenna 114) of the extension portion 116 to the processing system of the apparatus 102.

Although not illustrated in FIG. 1, in some configurations, the extension portion 116 may be a tail located on a distal portion (e.g., an end) of the apparatus 102. Such a tail may be positioned in a downward configuration (e.g., downwards towards the POI, such as the wireless node 122). In such a configuration, the tail may not move independent of the apparatus 102. In other words, the tail may not become closer to the POI (e.g., the wireless node 122) without the apparatus 102 also becoming closer to the POI (e.g., the wireless node 122). The tail may become closer to the POI (e.g., the wireless node 122) as the apparatus 102 navigates itself closer to the POI (e.g., the wireless node 122) using the propellers 104-107.

Although also not illustrated in FIG. 1, in some configurations, the extension portion 116 may have a fixed length. An extension portion 116 that has a fixed length may exist in various forms, types, configurations, and arrangements without deviating from the scope of the present disclosure. Generally, the extension portion 116 may be characterized as fixed if one or more of the dimensions (e.g., length, width, height, etc.) of the extension portion 116 are constant. In some aspects, the extension portion 116 may be directed, angled, pointed, or otherwise moved in one or more trajectories. For instance, the extension portion 116 may be fixed in length but directed, angled, pointed, or otherwise moved in the trajectory of the POI. The extension portion 116 may be directed, angled, pointed, or otherwise moved in a downward trajectory towards the location of the POI (e.g., the wireless node 122) during a first period of time (e.g., during a period of time when the wireless node 122 is being powered and data being collected) and subsequently directed, angled, pointed, or otherwise moved away from the location of the POI (e.g., the wireless node 122) during a second period of time (e.g., during a period of time when the apparatus 102 is traveling from one wireless node 122 to another wireless node 123).

In some other configurations, the extension portion 116 is not fixed in length. Accordingly, the length of the extension portion 116 may be adjusted. An extension portion 116 that has an adjustable length may exist in various forms, types, configurations, and arrangements without deviating from the scope of the present disclosure. Generally, the extension portion 116 can be characterized as adjustable if one or more dimensions (e.g., length, width, height, etc.) of the extension portion 116 are configured to increase and/or decrease. More specifically, the extension portion 116 can be characterized as adjustable if one or more dimensions of the extension portion 116 are configured to increase and/or decrease towards or away from the POI (e.g., the wireless node 122). The length of the extension portion 116 may be adjusted utilizing various mechanisms without deviating from the scope of the present disclosure. The extension portion 116 may be extended or retracted in various trajectories without deviating from the scope of the present disclosure. In some aspects, the extension portion 116 may be adjusted by extending towards and/or retracting from the POI (e.g., the wireless node 122). Accordingly, the extension portion 116 may provide the means for extending towards the POI and/or retracting from the POI (e.g., the wireless node 122). In some configurations, the extension portion 116 is adjusted utilizing a reel 110, as described in greater detail below.

In various configurations, the extension portion 116 of the apparatus 102 may be extended (e.g., downwards, horizontally, or any other suitable direction) utilizing any technique without deviating from the scope of the present disclosure. Generally, extending the extension portion 116 may involve drawing out, unreeling, unfolding, folding out, angling outwards, rotating outwards, gliding outwards, spiraling outward, unwinding, and/or otherwise moving at least a part of the extension portion 116 towards a particular area (e.g., the POI, such as the wireless node 122). One of ordinary skill in the art will understand that the extension portion 116 may be extended using various techniques without deviating from the scope of the present disclosure. However, any technique that can be utilized to extend (e.g., downward, horizontally, or any other suitable direction) the extension portion 116 of the apparatus 102 is within the scope of the present disclosure. Although non-limiting examples of such techniques may be described herein, one of ordinary skill in the art will understand that various other techniques may be utilized without deviating from the scope of the present disclosure.

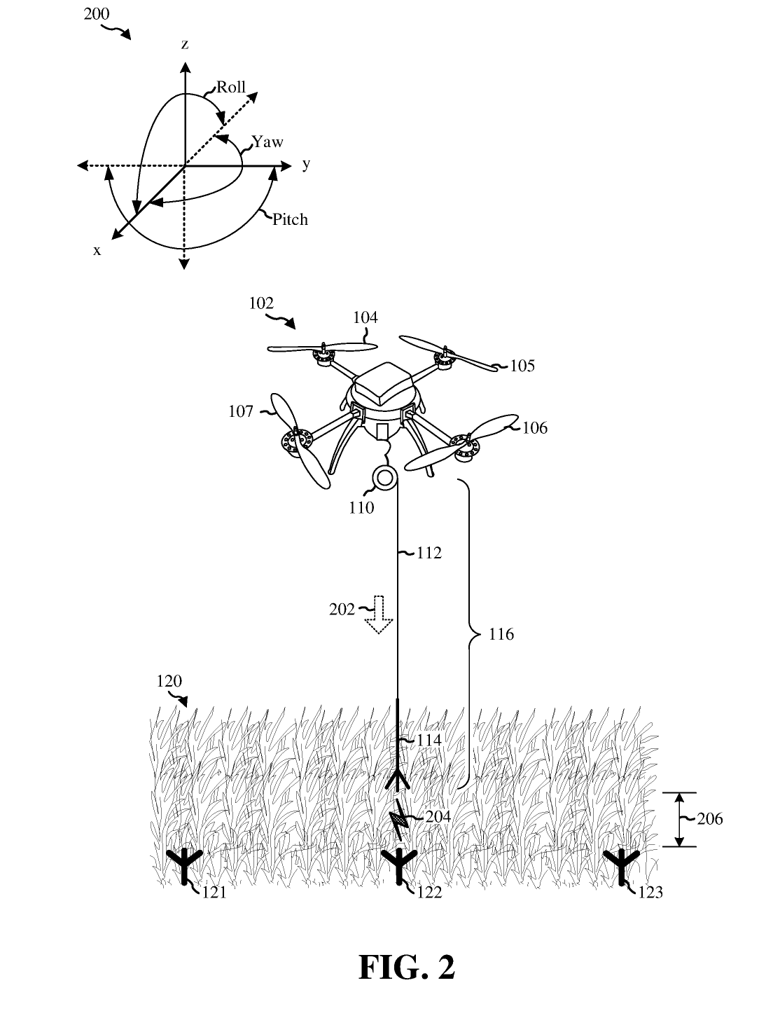

An example of such a technique may utilize a reel 110. Generally, a reel 110 is an object around which another material (e.g., the retractable transmission line 112) is wound. For instance, the reel 110 may have a cylindrical core and walls on the sides to retain the material wound around the cylindrical core. The reel 110 may turn, spin, or rotate in a first direction that causes the material (e.g., the retractable transmission line 112) to become wound around the core of the reel 110. The reel 110 may also turn, spin, or rotate in a second direction (different from the first direction) that causes the material (e.g., the retractable transmission line 112) to become unwound from the core of the reel 110. The reel 110 may be configured to extend and retract the retractable transmission line 112 such that the antenna 114 is lowered and raised, respectively, thereby adjusting the length of the extension portion 116. The reel 110 may be controlled or moved by any type of mechanism without deviating from the scope of the present disclosure. For example, the reel 110 may be controlled or moved by a mechanical motor, an electric motor, or any other suitable type of motor. In some configurations, the reel 110 may include a pulley, a wheel, a wheel with a grooved rim and/or flange, or any other suitable component configured for extending and retracting the retractable transmission line 112. The antenna 114 may be configured to transmit and receive various data signals and/or power signals, as described further below with reference to FIG. 2. As mentioned above, the apparatus 102 may move to a position that is in proximity to a particular POI. In the example illustrated in FIG. 1, the POI corresponds to the location of the wireless node 122. The apparatus 102 may move to a position that is in proximity to the wireless node 122 in order to obtain data from that wireless node 122. The wireless node 122 may be configured to measure and eventually transmit various types of information to the apparatus 102 without deviating from the scope of the present disclosure. Sensors may measure various parameters pertaining to environmental conditions. For example, such sensors may measure temperature, air moisture, radioactivity, smoke, heat, luminosity, pressure, soil moisture, infrared data, various chemicals, various types of images, etc. In some configurations, the sensor of the wireless node 122 may be a ‘sensor package,’ which is a device able to measure parameters corresponding to more than one environmental condition. For example, the sensor package may be a single device that is able to measure parameters corresponding to air moisture, airborne chemicals, air pressure, and air temperature. Although not a limitation of the present disclosure, sensors may be utilized in agricultural applications. Sensors may also be used in non-agricultural applications. Non-limiting examples of non-agricultural applications may include infrastructure, forestry, manufacturing, airports, shipping ports, land surveying, mines, construction sites, wildlife research, prospecting, storm tracking, weather forecasting, emergency response, environmental monitoring, search and rescue, and various other non-agricultural applications. In agricultural applications, sensors may be placed on or inserted into the soil where agricultural products are grown and harvested. Growers of agricultural products may utilize information gathered from such sensors to control irrigation, fertilization, and other growing conditions.

In some circumstances, wireless nodes (e.g., wireless nodes 121-123) including such sensors may be located throughout an area that does not provide a reliable source of power. For example, the wireless nodes 121-123 may be distributed throughout a large agricultural field (e.g., tens or hundreds of acres). Providing power to the wireless nodes 121-123 in a large agricultural field may be cost-prohibitive and/or labor-intensive. A conventional approach to providing power to the wireless nodes 121-123 may include running a network of wires throughout the large agricultural field. However, running a network of electrical wires throughout a large agricultural field can be expensive. Also, repair and maintenance on those wires can be costly. Another conventional approach to providing power to the wireless nodes 121-123 may involve the use of solar cells. However, solar cells may be unable to provide a reliable source of power to the wireless nodes 121-123 due to the unpredictable nature of weather conditions. For example, rainy, cloudy, and snowy days may not offer sufficient sunlight to the solar cells to reliably power the wireless nodes 121-123. Also, the agricultural plants 120 may block or interfere with the emanation of sunlight to the wireless nodes 121-123. Further, repair and maintenance of those solar cells can be expensive. Accordingly, conventional approaches to powering such wireless nodes 121-123 have certain limitations.

Accordingly to various aspects of the present disclosure, the wireless nodes 121-123 may be able to receive power using the apparatus 102. For example, the wireless nodes 121-123 may receive power through the extension portion 116 of the apparatus 102. The extension portion 116 of the apparatus 102 may provide power to the wireless nodes 121-123 utilizing various technologies without deviating from the scope of the present disclosure. In some configurations, the apparatus 102 may provide power to the wireless nodes 121-123 utilizing a wired connection. A wired connection refers to a physical coupling between a portion of a wireless node 122 and a portion of the extension portion 116. In other words, the distal part (e.g., the antenna 114) of the extension portion 116 may be configured to couple to the wireless node 122. After coupling to the wireless node 122, the distal part (e.g., the antenna 114) of the extension portion 116 may be further configured to provide power to the wireless node 122 via a wired connection, and receive data from the wireless node 122 via a wired connection. In configurations wherein a wired connection is formed between a portion (e.g., the antenna 114) of the extension portion 116 and the wireless node 122, a portion of the wireless node 122 and/or a portion of the extension portion 116 may include an attractant. Generally, an attractant refers to a substance that induces an attraction to something else. A non-limiting example of an attractant is a magnet. For example, a top portion of the wireless node 122 may include a magnet and/or a bottom portion of the extension portion 116 may include a magnet. The attractant(s) may be configured to facilitate the wired connection between the wireless node 122 and the extension portion 116.

In some other configurations, the apparatus 102 may provide power to the wireless nodes 121-123 utilizing a wireless connection. For example, the distal part (e.g., the antenna 114) of the extension portion 116 may be configured to provide power to the wireless node 122 via a wireless connection. The distal part (e.g., the antenna 114) of the extension portion 116 may also be configured to receive data from the wireless node 122 via a wireless connection. Various types of technologies may be implemented for wireless charging without deviating from the scope of the present disclosure. Regardless of the particular type of technology implemented, the distal part (e.g., the antenna 114) of the extension portion 116 of the apparatus 102 is likely required to be within a minimum distance relative to the wireless nodes 121-123. In other words, the power attenuation of signals traveling through that distance 130 may need to be below a particular threshold. Power attenuation across agricultural plants 120 may sometimes be referred to as ‘foliage loss.’ Foliage loss can contribute to substantial power attenuation during the transmission of power signals from the antenna 114 to the wireless node 122 as well as during the transmission of data signals from the wireless node 122 to the antenna 114. Some mathematical models (e.g., FITU-R models) estimate that foliage loss across 2.5 meters (e.g., the average height of corn at a mature stage) may be approximately 7 dB at 900 MHz and approximately 10.2 dB at 2.4 GHz. Other mathematical models (e.g., COST235) estimate that foliage loss across 2.5 meters may be approximately 18.6 dB at 900 MHz and approximately 18.5 dB at 2.4 GHz. Accordingly, in some circumstances, the distance 130 separating the distal part (e.g., the antenna 114) of the extension portion 116 of the apparatus 102 and the wireless node 122 may be too long to enable wireless charging of the wireless node 122 (and/or sensor thereof).

However, the apparatus 102 may be prohibited from lowering itself any more to reduce that distance 130. For example, the apparatus 102 may be an aerial drone that is prohibited from lowering itself any further for safety reasons. For instance, further lowering the apparatus 102 may substantially increase the likelihood of the apparatus 102 colliding with the agricultural plants 120. To reduce the distance 130 between the distal part (e.g., the antenna 114) of the extension portion 116 and the wireless node 122 without further lowering the apparatus 102, the extension portion 116 may be extended towards the wireless node 122, as further described below with reference to FIG. 2.

FIG. 2 is a diagram 200 illustrating an example of the apparatus 102 with the extension portion 116 extended towards the POI (e.g., the wireless node 122). One of ordinary skill in the art will understand that the extension portion 116 may extend or be moved using various techniques without deviating from the scope of the present disclosure. In the non-limiting example illustrated in FIG. 2, the extension portion 116 is moved further towards the POI (e.g., the wireless node 122) after positioning the apparatus 102 in proximity to the POI (e.g., the wireless node 122). The extension portion 116 is moved by utilizing the reel 110 to extend the length of the retractable transmission line 112 in a downward direction 202 towards the wireless node 122. In configurations wherein a wired connection is formed between the extension portion 116 and the wireless node 122, the retractable transmission line 112 is extended until a physical connection is formed between the wireless node 122 and the extension portion 116. In configurations wherein a wireless connection 204 is formed between the extension portion 116 and the wireless node 122, the retractable transmission line 112 is extended until the distance 206 separating the wireless node 122 and the extension portion 116 is equal to or less than the minimum distance required for a wireless connection 204 according to the particular technology implemented. One of ordinary skill in the art will readily be able to determine the appropriate distance 206 required based on the particular implementation utilized.

In some configurations, a relationship exists between the length of the extension portion 116 and the length of an obstruction near the POI. For example, the length of the extension portion 116 of the apparatus 102 may be at least as long as the length of an object preventing the apparatus 102 from positioning closer to the POI. Referring to FIG. 2, the length of the extension portion 116 of the apparatus 102 is at least as long as the height of the agricultural plants 120 that are preventing the apparatus 102 from lowering itself further to be closer to the wireless node 122. In other words, the length of the extension portion 116 is longer than the height of the agricultural plants 120. Without the extension portion 116 having such a length, the apparatus 102 may not be able to reach the wireless node 122. Accordingly, the extension portion 116 provides an advantage to the apparatus 102 for reaching the POI (e.g., the wireless node 122).

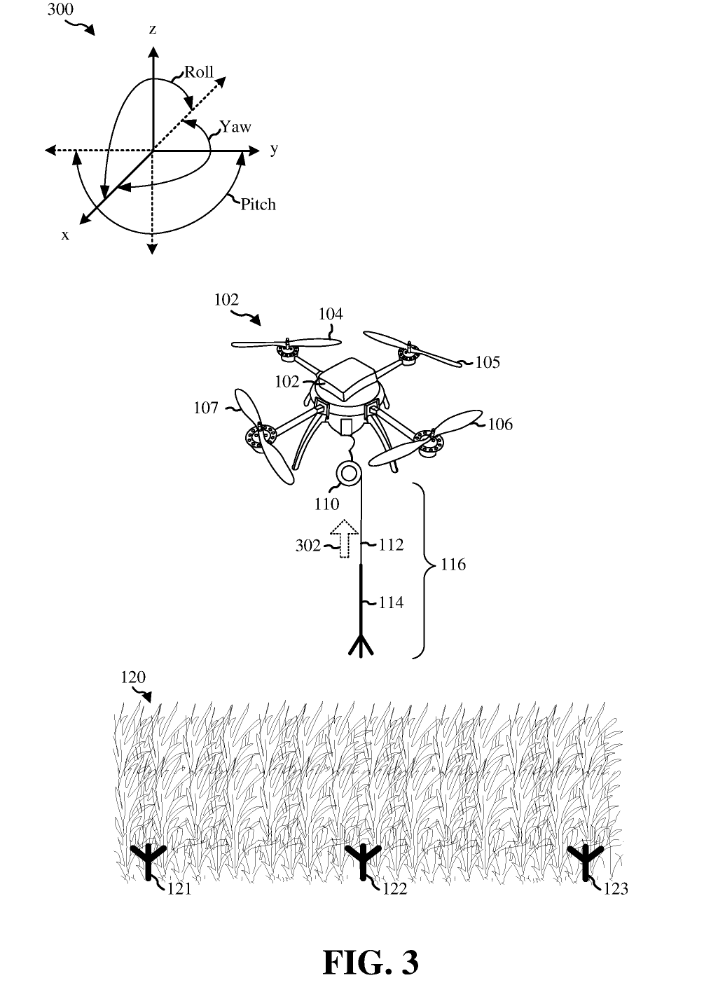

After the extension portion 116 is lowered towards the wireless node 122, the apparatus 102 may provide power to the wireless node 122 via the extension portion 116. By providing power to the wireless node 122, the wireless node 122 may be energized to perform various operations, including but not limited to those pertaining to making various measurements. Various non-limiting examples of sensors included in wireless nodes are described above and therefore will not be repeated. Subsequently, the wireless node 122 may transmit data, for example pertaining to those measurements, to the extension portion 116 of the apparatus 102. For example, the data from the wireless node 122 may be received by the antenna 114 of the extension portion 116. As described above, the connectivity between the wireless node 122 and the extension portion 116 may be wired and/or wireless without deviating from the scope of the present disclosure. Eventually, in some configurations, the apparatus 102 may retract the extension portion 116, as further described below with reference to FIG. 3.

FIG. 3 is a diagram 300 illustrating an example of the apparatus 102 with the extension portion 116 retracting away from the POI (e.g., the wireless node 122). Generally, retracting the extension portion 116 may be characterized as drawing in, withdrawing, pulling back, reeling in, extracting, folding up, folding in, angling inwards, rotating inwards, gliding inwards, and/or otherwise moving at least a portion of the extension portion 116 away from a particular area (e.g., the POI, such as the wireless node 122). One of ordinary skill in the art will understand that the extension portion 116 may be retracted using various techniques without deviating from the scope of the present disclosure. In the non-limiting example illustrated in FIG. 3, the extension portion 116 is retracted by utilizing the reel 110 to retract the retractable transmission line 112 in an upwards direction 302 away from the wireless node 122. In another example, the extension portion 116 may include hinges that allow sub-portions of the extension portion 116 to fold onto each other, thereby moving at least a portion of the extension portion 116 away from the POI (e.g., the wireless node 122). In yet another example, the extension portion 116 may include many sub-portions that glide onto or into one another in a manner that moves at least a portion of the extension portion 116 away from POI (e.g., the wireless node 122). In a further example, the extension portion 116 may be fixed, and the fixed extension portion 116 may be retracted by angling or rotating at least a segment of the extension portion 116 away from the POI (e.g., the wireless node 122). The extension portion 116 may be retracted for various reasons without deviating from the scope of the present disclosure. In some circumstances, the extension portion 116 may be retracted for safety reasons. For instance, if the extension portion 116 is not sufficiently retracted, a portion of the extension portion 116 may contact a portion of the agricultural plants 120, which may result in problems during aviation.

The apparatus 102 may retract the extension portion 116 based on various parameters without deviating from the scope of the present disclosure. In some configurations, the apparatus 102 may retract the extension portion 116 after receiving the data from the wireless node 122. In some other configurations, the apparatus 102 may retract the extension portion 116 after expiration of a time period during which no data is received from the wireless node 122. For example, in some circumstances, the wireless node 122 may be inoperable and therefore not transmitting data. After waiting for a period of time, the apparatus 102 may retract the extension portion 116 and possibly move to another wireless node (e.g., the adjacent wireless node 123). By moving to another wireless node (e.g., the adjacent wireless node 123), the apparatus 102 minimizes the likelihood of wasting time and power on attempting to collect data from a wireless node (e.g., the wireless node 122) that is inoperable.

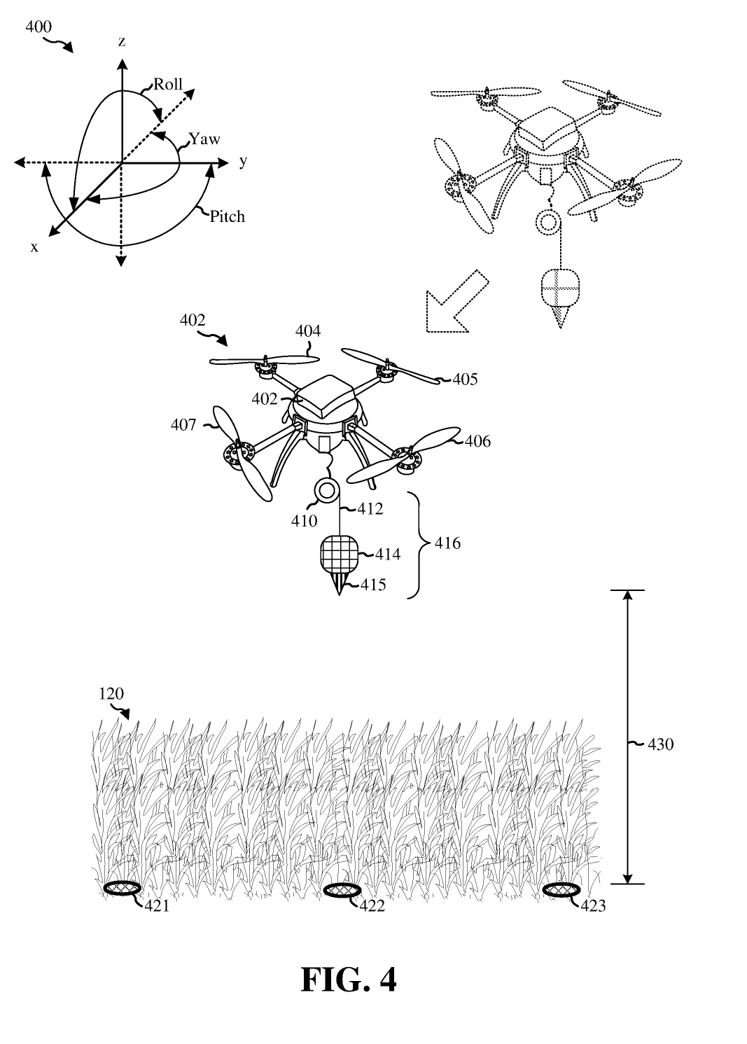

FIG. 4 is a diagram 400 illustrating another example of an apparatus 402 moving to a position in proximity to a POI. As used herein, the apparatus 402 may be represented by a drone, which may be a multi-propeller aerial vehicle. As used herein, a multi-propeller aerial vehicle (the drone) may be an aerial vehicle having a plurality of motorized propellers. For horizontal and vertical flight, the propellers may all generally point in the same direction. Furthermore, the drone may be autonomous or semi-autonomous. Various aspects pertaining to the POI is described in greater detail above and therefore will not be repeated. In the non-limiting example illustrated in FIG. 4, the POI is a particular location 422. Generally, the apparatus 402 may be any device that is configured to move in proximity to another object (e.g., a POI, such as the location 422). For purposes of illustration and not limitation, FIG. 4 shows that such an apparatus 402 may be an aerial drone. However, one of ordinary skill in the art will understand that the apparatus 402 may be a non-aerial drone without deviating from the scope of the present disclosure. For example, the apparatus 402 may be a terrestrial drone. The terrestrial drone may be configured to move to a position that is in proximity to the POI (e.g., the location 422) by moving towards that POI (e.g., the location 422) and positioning itself near that POI (e.g., the location 422). For example, the terrestrial drone may be configured to be sufficiently close to that POI (e.g., the location 422) such that its extension portion can reach that POI (e.g., the location 422). In some configurations, the apparatus 402 is an autonomous drone, which includes software and/or hardware modules that enables the apparatus 402 to control its own movements without relying upon constant control and navigation instructions from a user. For instance, an autonomous drone may be configured to locate the POI (e.g., the location 422) and navigate itself such that it is positioned in proximity to that POI. In some configurations, the apparatus 402 may be an aquatic drone. Various aspects pertaining to a drone (generally), an aerial drone, a terrestrial drone, an aquatic drone, and/or an autonomous drone described above with reference to FIGS. 1-3 are similar to a drone (generally), an aerial drone, a terrestrial drone, an aquatic, and/or an autonomous drone described with reference to FIGS. 4-6 and, therefore, the description of such similar features will not be repeated.

The apparatus 402 may include various components configured for moving the apparatus 402. The apparatus 402 may include a body that includes a processing system and/or a power source. The processing system, which is further described below with reference to FIG. 16, may provide the means for processing various data (e.g., data received from one or more sensors). The power source may be a battery, a solar cell, an electric generator, a fuel cell, or any other suitable component that provides power. The power source may provide the means for powering (e.g., means for powering one or more sensors). The apparatus 402 may include a plurality of motors that control the movement of the respective propellers 404-407 and thus the apparatus 402. The motors may be mechanical, electric, or any other suitable type of motors. The motors may provide the means for positioning the apparatus in proximity to a POI. Various aspects pertaining to the propellers 404-407 of the apparatus 402 is described in greater detail above with reference to the propellers 104-107 of FIG. 1 and therefore will not be repeated. One of ordinary skill in the art will understand that the apparatus 402 may include various components for movement without deviating from the scope of the present disclosure. For example, the apparatus 402 may include a fixed-wing, wherein the fixed-wing may be configured to assist the apparatus 402 with gliding and turning in the air. As another example, the apparatus 402 may be terrestrial and include one of many types of motor engines, which may be powered by gasoline, diesel, bio-fuels, and/or electric power generated by solar-based power generator and/or wind-based power generators. One of ordinary skill in the art understands that that apparatus 402 may include various components configured for moving the apparatus 402 without deviating from the scope of the present disclosure.

The apparatus 402 may also include an extension portion 416. The extension portion 416 may exist in various forms, types, configurations, and arrangements without deviating from the scope of the present disclosure. Any description herein with regard to the extension portion 416 of the apparatus 402 is provided for illustrative purposes and shall not be construed excluding alternative forms, types, configurations, and arrangements of the extension portion 416 of the apparatus 402. In the example illustrated in FIG. 4, the extension portion 416 of the apparatus 402 includes a sensor 414 at a distal part of a retractable transmission line 112. The retractable transmission line 412 may include a power line configured for providing power from the power source (as described above) of the apparatus 402 to a distal part (e.g., the sensor 414) of the extension portion 416. The retractable transmission line 412 may also include a communication line configured for communicating data from the distal part (e.g., the sensor 414) of the extension portion 416 to the processing system of the apparatus 402. In some configurations, the sensor 414 may also include a submergible portion 415, which is configured to be submerged below ground. For example, the submergible portion 415 may have a pointed or angled end region that facilitates its submersion into soil. Although not illustrated in FIG. 4, in some configurations, the extension portion 416 has a fixed length. In such configurations, the extension portion 416 may be fixed in a particular direction (e.g., downwards, towards the location of the POI). In some other configurations, the extension portion 416 is not fixed in length. Accordingly, the length of the extension portion 416 may be adjusted. The extension portion 416 may provide the means for extending towards the POI (e.g., the location 422). Various features of the extension portion 416 described with reference to FIGS. 4-6 may be similar to the features of the extension portion 116 described with reference to FIGS. 1-3 and, therefore, the description of such similar features will not be repeated. In the non-limiting example illustrated in FIG. 4, the extension portion 416 includes a reel 410. The reel 410 may be configured to extend and retract the retractable transmission line 412 such that the sensor 414 is lowered and raised, respectively, thereby adjusting the length of the extension portion 416. Various features of the reel 410 described with reference to FIGS. 4-6 may be similar to the features of the reel 110 described with reference to FIGS. 1-3 and, therefore, the description of such similar features will not be repeated.

As mentioned above, the apparatus 402 may move to a position that is in proximity to a particular POI. In the example illustrated in FIG. 4, the POI corresponds to the location 422. Sensors may measure various parameters pertaining to environmental conditions. For example, such sensors may measure temperature, air moisture, radioactivity, smoke, heat, luminosity, pressure, soil moisture, infrared data, various chemicals, various types of images, etc. In some configurations, the sensor 414 may be a ‘sensor package,’ which is a device able to measure parameters corresponding to more than one environmental condition. For example, the sensor package may be a single device that is able to measure parameters corresponding to air moisture, airborne chemicals, air pressure, and air temperature. In some circumstances, the sensor 414 may be used in agricultural applications. The sensor 414 may also be used in non-agricultural applications. In agricultural applications, the sensor 414 may be placed on or inserted into the soil where agricultural products are grown and harvested, e.g., utilizing the submergible portion 415. Growers of agricultural products may utilize information gathered from such sensors to control irrigation, fertilization, and other growing conditions.

As mentioned above, conventional systems for measuring environmental conditions may utilize various sensors deployed throughout a large geographic area (e.g., tens or hundreds of acres) using wires, batteries, and/or solar cells. However, for at least the reasons provided above, such conventional systems may be cost-prohibitive and labor-intensive in certain applications. Aspects of the present disclosure provide advantages over conventional systems for obtaining data from sensor, especially sensors located throughout a large geographic area. Firstly, because the sensor 414 is connected to the apparatus 402, the sensor 414 is provided with a reliable source of power from the apparatus 402. Secondly, because the sensor 414 is connected to the apparatus 402, the sensor 414 is provided with a reliable connection through which sensor data can be transmitted from the sensor 414 to the apparatus 402. Thirdly, because the sensor 414 is connected to the apparatus 402, additional sensors are not required to be distributed throughout that large geographic area, which reduces material costs. Aspects of the present disclosure provide various other advantages readily appreciated by one of ordinary skill in the art.

In some circumstances, the sensor 414 may need to measure certain parameters that are lower in elevation than the elevation of the apparatus 402. For example, the sensor 414 may need to measure certain parameters at one of the locations 421-423 near the ground or soil. However, such parameters may not be reliably and/or accurately measured from a particular distance 430. As described above, foliage loss can contribute to substantial signal attenuation. The effects of foliage loss are described in greater detail above and therefore will not be repeated. Nevertheless, in some circumstances, the distance 430 separating the sensor 414 and the POI (e.g., the location 422) may be too long to enable reliable and/or accurate measurements.

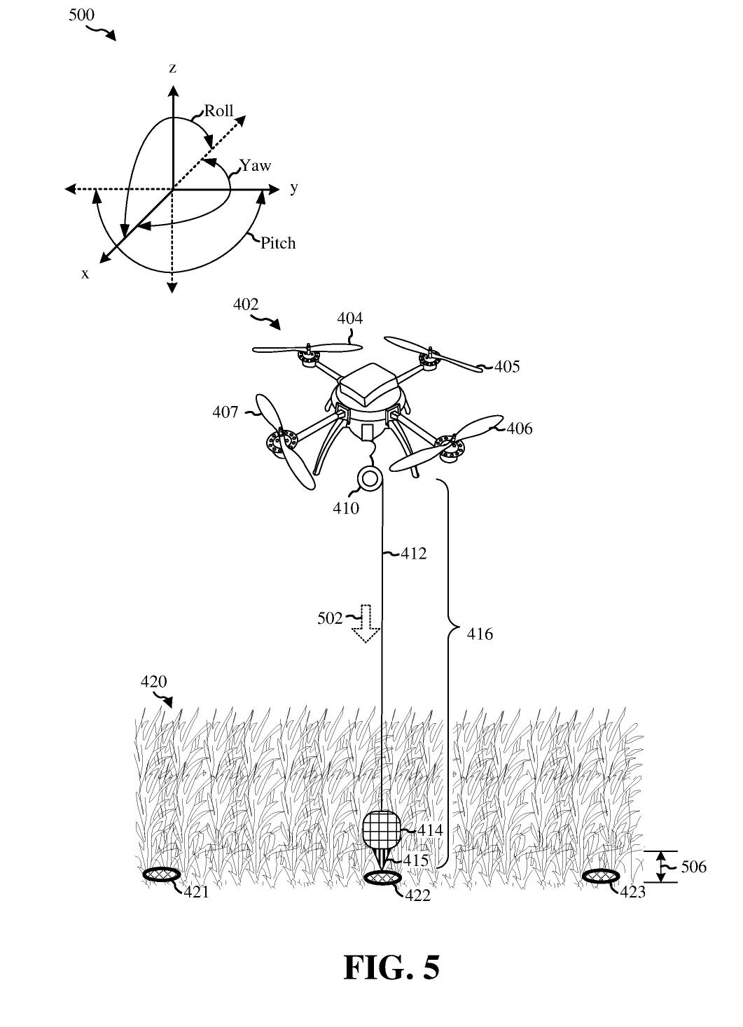

However, the apparatus 402 may be prohibited from lowering itself any more to reduce that distance 430. For example, the apparatus 402 may be an aerial drone that is prohibited from lowering itself any further for safety reasons. For instance, further lowering the apparatus 402 may substantially increase the likelihood of the apparatus 402 colliding with the agricultural plants 120. To reduce the distance 430 between the sensor 414 and the location 422 without further lowering the apparatus 402, the extension portion 416 may be extended towards the POI (e.g., the location 422), as further described below with reference to FIG. 5.

FIG. 5 is a diagram 200 illustrating an example of the apparatus 402 with the extension portion 416 extended towards the POI (e.g., the location 422). One of ordinary skill in the art will understand that the extension portion 416 may be extend or be moved using various techniques without deviating from the scope of the present disclosure. In the non-limiting example illustrated in FIG. 5, the extension portion 416 is moved further towards the POI (e.g., the location 422) after positioning the apparatus 402 in proximity to the POI (e.g., the location 422). The extension portion 416 is moved by utilizing the reel 410 to extend the length of the retractable transmission line 412 in a downward direction 502 towards the POI (e.g., the location 422). For example, the retractable transmission line 112 is extended until the sensor 414 is within a minimum distance 506 in relation to that particular POI (e.g., the location 422). Sensors may vary with regard to the minimum distance 506 required for reliable and/or accurate measurements of various environmental conditions. For example, the minimum distance 506 for a sensor that measures air moisture at the POI (e.g., the location 422) may be less than the minimum distance 506 for a sensor that measures air temperature at that POI (e.g., the location 422). One of ordinary skill in the art will understand that various distances may be implemented based on specific implementations without deviating from the scope of the present disclosure.

In some configurations, a relationship exists between the length of the extension portion 416 and the length of an obstruction near the POI. For example, the length of the extension portion 416 of the apparatus 402 is at least as long as the length of an object preventing the apparatus 402 from positioning closer to the POI. Referring to FIG. 5, the length of the extension portion 416 of the apparatus 402 is at least as long as the height of the agricultural plants 120 that are preventing the apparatus 402 from lowering itself further to be closer to the location 422. In other words, the length of the extension portion 416 is longer than the height of the agricultural plants 120. Without the extension portion 416 having such a length, the apparatus 102 may not be able to position the sensor 414 in sufficiently close proximity to the POI (e.g., the location 422). Accordingly, the extension portion 416 provides an advantage to the apparatus 402 for reaching the POI (e.g., the location 422).

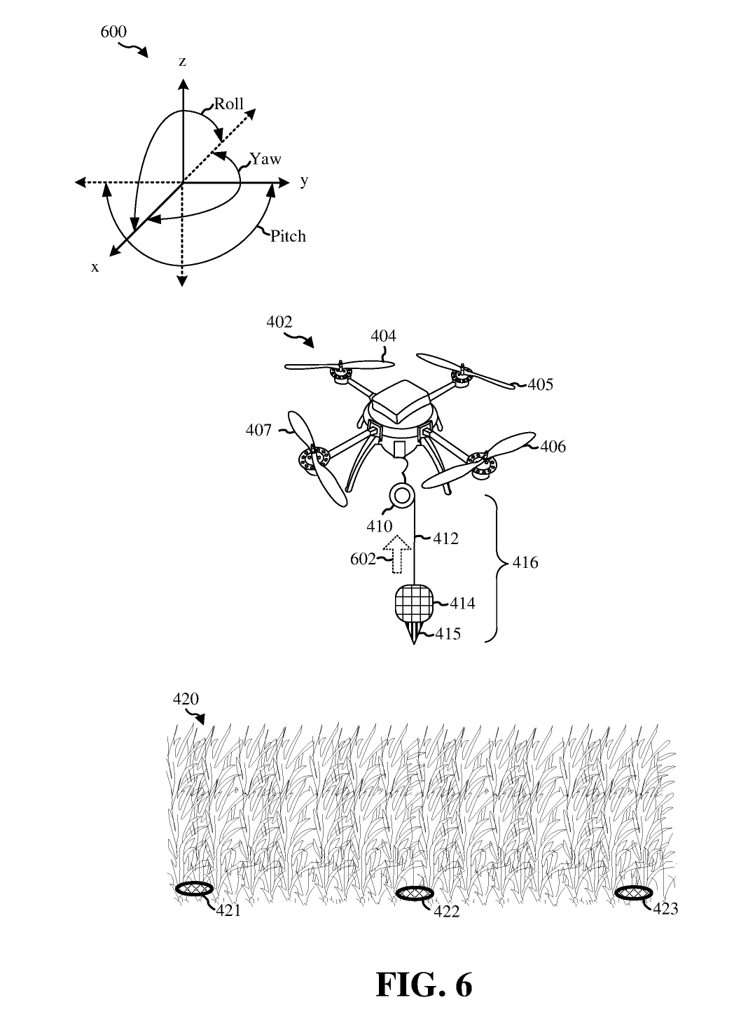

After the extension portion 416 is lowered towards the POI (e.g., the location 422), the apparatus 402 may provide power to the sensor 414 via the extension portion 416. By providing power to the sensor 414, the sensor 414 may be energized to perform various operations pertaining to making various measurements. Various non-limiting examples of sensors are described above and therefore will not be repeated. Subsequently, the sensor 414 may transmit data pertaining to those measurements to the apparatus 402. For example, the data from the sensor 414 may be transmitted via the retractable transmission line 412. Eventually, in some configurations, the apparatus 402 may retract the extension portion 416, as further described below with reference to FIG. 6.

FIG. 6 is a diagram 600 illustrating an example of the apparatus 402 with the extension portion 416 retracting away from the POI (e.g., the location 422). One of ordinary skill in the art will understand that the extension portion 416 may be retracted using various techniques without deviating from the scope of the present disclosure. In the non-limiting example illustrated in FIG. 6 the extension portion 416 is retracted by utilizing the reel 410 to reduce the length of the retractable transmission line 412 in an upwards direction 602 away from the POI (e.g., location 422). The extension portion 416 may be retracted for safety reasons. For example, if the extension portion 416 is not sufficiently retracted, a segment of the extension portion 416 may contact a portion of the agricultural plants 120, which may result in problems during aviation. The apparatus 402 may retract the extension portion 416 based on various parameters without deviating from the scope of the present disclosure. In some configurations, the apparatus 402 may retract the extension portion 416 after receiving the data from a sensor.

One of ordinary skill in the art will understand that sensors may be arranged in various configurations without deviating from the scope of the present disclosure. For example, each of the locations 421-423 may include a cluster of sensors. Generally, a cluster of sensors may refer to two or more sensors located in a common area or region. If one (or more) of the sensors in the cluster of sensors fails or becomes inoperable, the apparatus 102, 402 may utilize another one (or more) of the other sensors in the cluster of sensors. Without a cluster of sensors, the failure of a single sensor may result in the failure of data collection from the POI associated with that sensor. Further, waiting to replace or repair that sensor may delay data collection from the POI associated with that sensor. Even further, the costs associated with repairing a failed or inoperable sensor may be substantially higher than the cost of replacing or abandoning such that sensor. As described in greater detail above, some configurations of the apparatus 102, 402 may include a sensor package. Each sensor in the cluster of sensors may detect different conditions. For example, a first sensor of the cluster of sensors may detect soil temperature, and a second sensor of the cluster of sensors may detect air humidity. Accordingly, the sensor package may measure the soil temperature using the first sensor and concurrently or simultaneously measure air humidity using the second sensor.

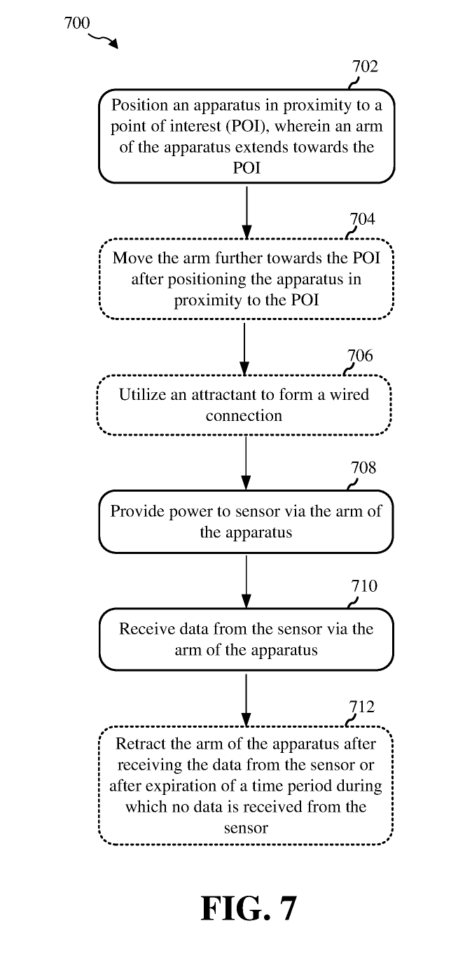

FIG. 7 is a diagram illustrating an example of various methods and/or processes operable at an apparatus. Such an apparatus may be the apparatus 102 described above with reference to FIGS. 1-3 and/or the apparatus 402 described above with reference to FIGS. 4-6. At block 702, the apparatus may position the apparatus in proximity to a POI, wherein an extension portion of the apparatus extends towards the POI. For example, referring to FIG. 1, the apparatus 102 determines to move to a position that is proximate to the wireless node 122. As another example, referring to FIG. 4, the apparatus 402 determines to move to a position that is proximate to the location 422. In some configurations, the positioning the apparatus in proximity to the POI may include positioning the apparatus in proximity to a wireless node located at the POI. For example, referring to FIG. 2, the apparatus 102 is positioned in proximity to the wireless node 122, which is located at the POI. In some configurations, the positioning the apparatus in proximity to the POI may include at least partially submerging a sensor below ground. For example, referring to FIG. 5, the submergible portion 415 of the sensor 414 is at least partially submerged below ground.

In some configurations, at block 704, the apparatus may move the extension portion of the apparatus further towards the POI after positioning the apparatus in proximity to the POI. For example, referring to FIG. 2, the apparatus 102 may move the extension portion 116 further towards the POI (e.g., the wireless node 122) after positioning the apparatus 102 in proximity to the POI (e.g., the wireless node 122). The extension portion 116 is moved by utilizing the reel 110 to extend the length of the retractable transmission line 112 in a downward direction 202 towards the wireless node 122. As another example, referring to FIG. 5, the apparatus 402 may move the extension portion 416 further towards the POI (e.g., the location 422) after positioning the apparatus 402 in proximity to the POI (e.g., the location 422). The extension portion 416 is moved by utilizing the reel 410 to extend the length of the retractable transmission line 412 in a downward direction 502 towards the location 422.

In some configurations, at block 706, the apparatus may utilize an attractant to form a wired connection between the extension portion of the apparatus and the wireless node. The attractant may be located on at least one of the extension portion or the wireless node. For example, referring to FIG. 2, the apparatus 102 may utilize an attractant (e.g., a magnet, an electromagnet, etc.) located on a portion of the extension portion 116 of the apparatus 102 and/or the wireless node 122 to form a wired connection (not shown) between the extension portion 116 and the wireless node 122. The data from the wireless node 122 may be received by the extension portion 116 via that wired connection. The power to the wireless node 122 may be provided by the extension portion 116 via that wired connection.

At block 708, the apparatus may provide power to a wireless node 122 via the extension portion of the apparatus. In some configurations, as illustrated in FIGS. 1-3, the wireless node 122 is detached from the apparatus 102. In such configurations, the apparatus 102 may provide power to the wireless node 122 via a wireless connection 204. Also in such configurations, although not illustrated in FIGS. 1-3, the apparatus 102 may provide power to the wireless node 122 via a wired connection. As described in greater detail above, the extension portion 116 and/or the wireless node 122 may include an attractant configured to facilitate forming the wired connection. In some other configurations, as illustrated in FIGS. 4-6, a sensor 414 is attached to the apparatus 402. For instance, the sensor 414 is attached to or included as a part of the extension portion 416 of the apparatus 402. As described in greater detail above, the sensor 414 may include a submergible portion 415, which is configured to be submerged below ground. As also described in greater detail above, the length of the extension portion 116, 416 of the apparatus 102, 402 may be at least as long as the length of an object (e.g., agricultural plants 120) preventing the apparatus 102, 402 from positioning closer to the POI (e.g., the wireless node 122, the location 422).

At block 710, the apparatus may receive data from the wireless node 122 via the extension portion of the apparatus. In some configurations, as illustrated in FIGS. 1-3, the wireless node 122 is detached from the apparatus 102. In such configurations, the apparatus 102 may determine to receive data from the wireless node 122 via a wireless connection 204. Also in such configurations, although not illustrated in FIGS. 1-3, the apparatus 102 may receive data from the wireless node 122 via a wired connection. As described in greater detail above, the extension portion 116 and/or the wireless node 122 may include an attractant configured to facilitate forming the wired connection. In some other configurations, as illustrated in FIGS. 4-6, a sensor 414 is attached to the apparatus 402. For instance, the sensor 414 is attached or included as a part of the extension portion 416 of the apparatus 402. As described in greater detail above, the sensor 414 may include a submergible portion 415, which is configured to be submerged below ground. For example, the sensor 414 and/or the submergible portion 415 may be placed at, on, above, and/or underneath the POI (e.g., location 422). As also described in greater detail above, the length of the extension portion 116, 416 of the apparatus 102, 402 may be at least as long as the length of an object (e.g., agricultural plants 120) preventing the apparatus 102, 402 from positioning closer to the POI (e.g., the wireless node 122, the location 422).

In some configurations, at block 712, the apparatus may retract the extension portion of the apparatus after receiving the data from the wireless node 122 or location 422 or after expiration of a time period during which no data is received from the wireless node 122 or location 422. For example, referring to FIG. 3, the apparatus 102 may retract the extension portion 116 after expiration of a time period during which no data is received from the wireless node 122. For example, in some circumstances, the wireless node 122 may be inoperable and therefore not transmitting data. After waiting for a period of time, the apparatus 102 may retract the extension portion 116 and possibly move to another wireless node (e.g., the adjacent wireless node 123). By retracting the extension portion 116 and possibly moving to another wireless node (e.g., the adjacent wireless node 123), the apparatus 102 minimizes the likelihood of wasting time and power on attempting to collect data from a wireless node that is inoperable.

The methods and/or processes described with reference to FIG. 7 are provided for illustrative purposes and are not intended to limit the scope of the present disclosure. The methods and/or processes described with reference to FIG. 7 may be performed in sequences different from those illustrated therein without deviating from the scope of the present disclosure. Additionally, some or all of the methods and/or processes described with reference to FIG. 7 may be performed individually and/or together without deviating from the scope of the present disclosure. It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

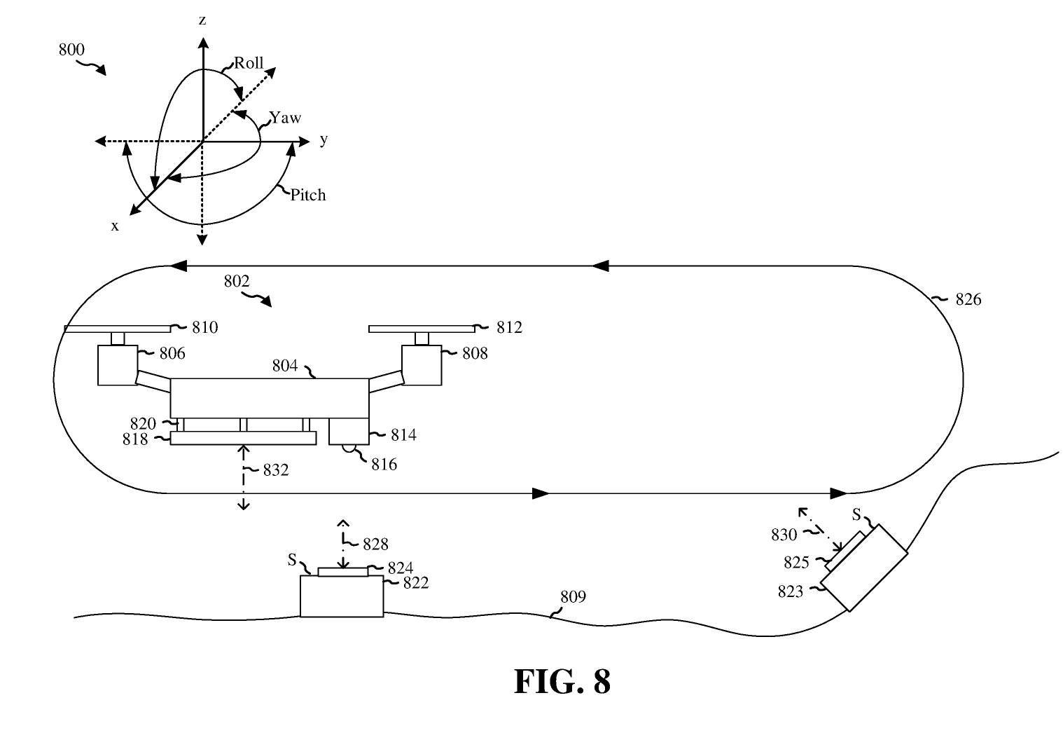

FIG. 8 is a diagram 800 illustrating an example of an apparatus 802 mapping a space including one or more locations of one or more wireless nodes 822, 823. As used herein, the apparatus 802 may be represented by a drone, which may be a multi-propeller aerial vehicle. As used herein, a multi-propeller aerial vehicle (the drone) may be an aerial vehicle having a plurality of motorized propellers. For horizontal and vertical flight, the propellers may all generally point in the same direction. Furthermore, the drone may be autonomous or semi-autonomous. As used herein, mapping may mean an act or process of making an electronic map, charting, plotting, recording, drawing, diagraming, and/or representing a physical space in an electronic format or otherwise in a format usable by the apparatus to locate and/or avoid landmarks/locations including the one or more wireless nodes 822, 823. The apparatus 802 may be moving in a space above or adjacent to a surface 809. The space may be bounded by predefined limits. The surface 809 may be, for example, the ground in an agricultural or outdoor application, or a floor of a building in an indoor application. On the surface 809, there may be positioned one or more wireless nodes 822, 823. Each wireless node 822, 823 may be a POI. Each wireless node 822, 823 may be a type of device that is powered-on by the reception of energy emitted from the apparatus 802 by way of a radio wave signal. Each wireless node 822, 823 may therefore have an antenna 824, 825 having an antenna beam pattern that, for purposes of discussion and without any intent of limitation, is perpendicular to the surface “S” of the wireless node 822, 823. The antenna beam pattern may be directional, meaning that gain varies as a function of the angle projected from the surface S, or omnidirectional, meaning that antenna gain is substantially uniform in all directions projecting from the surface S. The frequency and power of the radio wave signal, and gain of the antenna 818 of the apparatus 802, needed to power-on the wireless node 822, 823 may be determined by a person of skill in the art. Although one antenna is described, nothing herein is meant to exclude either the apparatus 802 or the wireless node 822, 823 from having more than one antenna 818, 824, 825. For example the apparatus 802 and/or the wireless node 822, 823 may have multiple antennas for Wi-Fi, wide access network (WAN), or other radio technology. For example, the antenna 818 of the apparatus 802 may be a planar array of multiple antennas. As used herein, a planar array may mean an array of regularly spaced antenna elements. In one example, the antenna 818 of the apparatus 802 may include two or more sub-antennas. The antenna beam of each sub-antenna could be used separately or any number of the antenna beams of the sub-antennas could be combined to form a single composite antenna beam. The use of multiple antenna beams on the apparatus 802 provides an ability of the apparatus to get better measurements and understanding of its orientation and location with respect to an antenna 824, 825 of a wireless node 822, 823.

The apparatus 802 may include various components configured for moving the apparatus 802. The apparatus 802 may include a body 804 that includes a processing system and/or a power source. The processing system, which is further described below with reference to FIG. 16, may provide the means for processing various data (e.g., data received from one or more wireless nodes). The power source may be a battery, a solar cell, an electric generator, a fuel cell, or any other suitable component that provides power. The power source may provide the means for powering (e.g., means for powering the apparatus and/or one or more wireless nodes 822, 823). The apparatus 802 may include a plurality of motors 806, 808 that control the movement of the respective propellers 810, 812 and thus the apparatus 802. Each motor 806, 808 may be mechanical, electric, or any other suitable type of motor. The propellers 810, 812 (and/or the motors 806, 808) may provide the means for positioning the apparatus in proximity to a POI (e.g., a wireless node 822, 823). Various aspects pertaining to the propellers 810, 812 of the apparatus 802 are described in greater detail above with reference to the propellers 104-107 of FIG. 1 and therefore will not be repeated. One of ordinary skill in the art will understand that the apparatus 802 may include more than the two propellers 810, 812 shown without deviating from the scope of the present disclosure. The illustration of FIG. 8 depicts two propellers 810, 812 to avoid clutter. For example, the apparatus 802 may include any number of propellers including, for example, four, six, eight, ten, or more propellers without deviating from the scope of the present disclosure. In one aspect, an apparatus 802 with more than four propellers may be able to orient itself in space with six degrees of freedom (6DoF) without having to tilt the body of the motor 806, 808 rotating the propeller 810, 812. In other words, the orientation of the apparatus 802 in space with 6DoF may be accomplished by independently changing the speed and direction of each of the propellers 810, 812 without tilting the body of the motor 806, 808 of the propeller 810, 812 with respect to the body 804 of the apparatus 802. One of ordinary skill in the art will understand that the apparatus 802 may include various components for movement without deviating from the scope of the present disclosure. For example, the apparatus 802 may include a fixed-wing, wherein the fixed-wing may be configured to assist the apparatus 802 with gliding and turning in the air. As another example, the apparatus 802 may be terrestrial and include one of many types of motor engines, which may be powered by gasoline, diesel, bio-fuels, and/or electric power generated by solar-based power generator and/or wind-based power generators. One of ordinary skill in the art understands that that apparatus 802 may include various components configured for moving the apparatus 802 without deviating from the scope of the present disclosure.

The apparatus 802 may include various components configured for guiding the apparatus 802 in 2D and/or 3D space. For example, the apparatus may include guidance package 814. The guidance package 814 may include a Global Positioning System (GPS), a Global Information System (GIS), a satellite system, a signal triangulation system, an inertial navigation unit, a simultaneous location and mapping (SLAM) unit, a real time kinematic (RTK) unit, and/or various other suitable positioning and/or geolocation systems. The guidance package 814 may include a range measurement device, such as a sonar device, a radar device, a vision device (e.g., a camera), a laser scanner device, and/or a laser range finder device. An acoustic and/or optical window 816 may be provided for the guidance package 814. In some implementations, one or more range measurement devices may be mounted on the body 804 of the apparatus 802. The range measurements device(s) and features of the guidance package 814 may be useful for mapping the environment surrounding the apparatus 802 as the apparatus moves through space in the vicinity of the one or more wireless nodes 822, 823.

The apparatus 802 may include an antenna 818 configured for transmitting a first signal from the apparatus 802 and receiving a second signal, different from the first signal, at the apparatus 802. The antenna 818 may be a planar antenna comprised of a plurality of planar metallic patches (not shown). The antenna 818 may be formed of a plurality of antennas, where each antenna can be used individually and/or the plurality of antennas can be used collectively to form one composite antenna. The antenna beam pattern may be directional or omnidirectional. When the antenna 818 is formed of a plurality of antennas, the composite antenna beam pattern of the antenna 818 may be electronically steered by, for example, individually adjusting the phase of a signal being received or transmitted from each of the plurality of antennas. The antenna beam pattern, the frequency, and the power of the radio wave signal needed to power-on a wireless node 822, 823 may be determined by a person of skill in the art. One of ordinary skill in the art will understand how to select the antenna 818 without deviating from the scope of the present disclosure. The antenna 818 may be fixed (e.g., secured, bound, held) to the body 804 of the apparatus 802 using non-extendable and/or extendable portions 820. In some implementations, the antenna 818 of the apparatus 802 may be fixed to the apparatus 802 so that the orientation of the apparatus 802 and the orientation of the antenna 818 are the same. That is, the antenna 818 (or antenna beam pattern) moves with the same six degrees of freedom available to the apparatus 802. In some implementations, the antenna 818 may be fixed to the body 804 of the apparatus 802 using extendable portions 820 so that the antenna 818 may move independently from the body 804 of the apparatus 802. In such implementations, the antenna 818 may be positioned with up to six degrees of freedom relative to the body 804 of the apparatus 802. In other implementations, the antenna may be positioned with at least an ability to move in pitch and roll directions relative to the body 804 of the apparatus 802.

FIG. 8 depicts the apparatus 802 moving through space above one or more wireless nodes 822, 823. In some implementations, the wireless nodes 822, 823 may include sensors used, for example, to measure the environment surrounding the wireless nodes 822, 823. In some implementations, the wireless nodes 822, 823 may be generic devices with no sensing capabilities. For example, each wireless node 822, 823 may be a remote base station with a battery, and the apparatus 802 (e.g., drone, autonomous drone) is present to charge the base station battery so a user does not have to physically go out to the location of the wireless node 822, 823.

In the implementation illustrated in FIG. 8, the apparatus may be mapping a space including one or more locations of one or more wireless nodes 822, 823. The mapping may comprise moving (e.g., flying) the apparatus 802 in a pattern 826 within the space to identify landmarks within the space, the landmarks including the one or more wireless nodes 822, 823. The space may be bounded. The pattern 826 illustrated in FIG. 8 is not intended to be limiting. The pattern 826 may be any pattern, such as, for example, a crisscross or grid pattern, a racetrack pattern (as shown), a figure eight pattern, or a random or pseudo-random pattern determined by the apparatus 802 during mapping. When the movement is flying, for example, such a random or pseudo-random pattern may be flown by an autonomous drone using, for example, SLAM to map the landmarks and obstacles encountered in a given space. As used herein, the terms flying, flown, and their derivatives include the aspect of hovering or remaining stationary at a given location in space. During the mapping, the apparatus 802 may use the guidance package 814, including any geolocation system, accelerometer, gyroscope, inertial guidance unit (e.g., for dead-reckoning), and/or simultaneous location and mapping (SLAM) unit to map the space being moved through. The apparatus 802, which may be an autonomous drone, may map the space including the one or more locations of the one or more wireless nodes 822, 823 and may use the map to determine whether the apparatus 802 is in proximity to a first wireless node 822 of the one or more wireless nodes 822, 823. The apparatus 802 may use the map for establishing a mapped location of a first wireless node of the one or more wireless nodes 822, 823 based on the mapping. Other ways to determine whether the apparatus 802 is in proximity to a first wireless node 822 of the one or more wireless nodes 822, 823 are acceptable for use without deviating from the scope of the present disclosure.

The apparatus 802, which may be an autonomous drone, may map the space including the one or more locations of the one or more wireless nodes 822, 823 and may use the map to determine an orientation of an antenna 824 of the first wireless node 822 (where the antenna 824 of the first wireless node 822 may be representative of one or more antennas of the first wireless node 822). The configuration of wireless nodes 822, 823 may vary greatly. Some wireless nodes may have one or more planar antennas fixed to a surface, S, of the wireless node, while other wireless nodes may have one or more antennas that each have a non-planar physical structure that extends from a surface of the wireless node. A combination of planar and non-planar antenna structures is also within the scope of the disclosure. The antenna configuration of a set of wireless nodes 822, 823 may be stored in a compendium of information that is stored on the apparatus 802 or available to the apparatus 802. Thus, the apparatus 802 may use such a compendium of information to determine what type of antenna to expect at a given location (POI) for a given wireless node 822, 823. The apparatus may then use the mapping data to determine the shape and orientation of a given wireless node 822, 823 and based on the mapping data determine the orientation of the antenna of the wireless node 822, 823. Other ways to determine the orientation of the antenna 824, 825 of a given wireless node 822, 823 are acceptable for use without deviating from the scope of the present disclosure. For example, the antenna 818 of the apparatus 802 may include a plurality of sub-antennas. The amplitude and/or phase of signals from the sub-antennas can be measured individually and/or collectively to determine the location and orientation of the apparatus 802 with respect to the location and orientation of a given wireless node 822, 823. Accordingly, via one or another exemplary method, the apparatus 802 may determine an orientation of an antenna 824 of the first wireless node 822 with respect to an antenna 818 of the apparatus 802.

In the example of FIG. 8, the first wireless node 822 may be recognized as having a planar antenna 824 on the surface S of the wireless node 822. In the implementation of FIG. 8, the planar antenna 824 may have a directional or omnidirectional antenna beam pattern (not shown) that projects from the surface S of the wireless node 822 along an axis that may be referred to as the boresight axis, or the boresight 828, of the antenna 824. Because the wireless node 822 is lying flat on the surface 809 (e.g., the ground or floor) on which the wireless node 822 is positioned, the antenna beam pattern, and the boresight 828, of the planar antenna 824 is pointed in an upward direction, perpendicular to, or 90 degrees from the horizontal. In contrast, because the second wireless node 823 is lying on an angle (due to its being positioned on a slope on the ground or floor) the antenna beam pattern, and the boresight 830, of the planar antenna 825 is pointed in a diagonal direction, 45 degrees from the horizontal. If the antenna beam pattern of the planar antenna 824, 825 of the wireless node 822, 823 is directional, then in order to take advantage of the directional gain of the antenna beam, a corresponding antenna 818 on the apparatus 802 would need to be aligned along the same axis as the planar antenna 825 of the wireless node 822, 823. Accordingly, to align the boresight 828 of the planar antenna 824 of the first wireless node 822 with the boresight 832 of the antenna 818 on the apparatus 802, the antenna beam of the antenna 818 on the apparatus 802 would need to point at an angle of 90 degrees downward toward the ground (perpendicular to the ground). Accordingly, to align the boresight 830 of the planar antenna 825 of the second wireless node 823 with the boresight 832 of the antenna 818 on the apparatus 802, the antenna beam of the antenna 818 on the apparatus 802 would need to point at an angle of 45 degrees downward toward the ground (diagonal to the ground). Therefore, determining the orientation of the antenna of the wireless node 822, 823 in proximity to the apparatus 802 is advantageous to, for example, increase wireless power transfer from one antenna to another (e.g., to maximize the antenna gain realized by the antenna 818 of the apparatus 802). Determining the orientation of the antenna of the wireless node 822, 823 in proximity to the apparatus 802 may also be advantageous as the wireless node 822, 823 may not be oriented in an expected direction due to any number of reasons (e.g., the wireless node may have been bumped, jostled, or otherwise displaced by human, animal, or natural (e.g., storm) intervention, or by the act of plowing a field, or the growth of a plant in the vicinity of the wireless node, etc.). Thus, in some implementations, the apparatus 802 may map the space including one or more locations of one or more wireless nodes, determine whether the apparatus is in proximity to a first wireless node of the one or more wireless nodes, and determine an orientation of an antenna of the first wireless node. The determination of the orientation of the antenna 824 of the first wireless node 822 may be based on the mapping or on some other action taken by the apparatus 802.

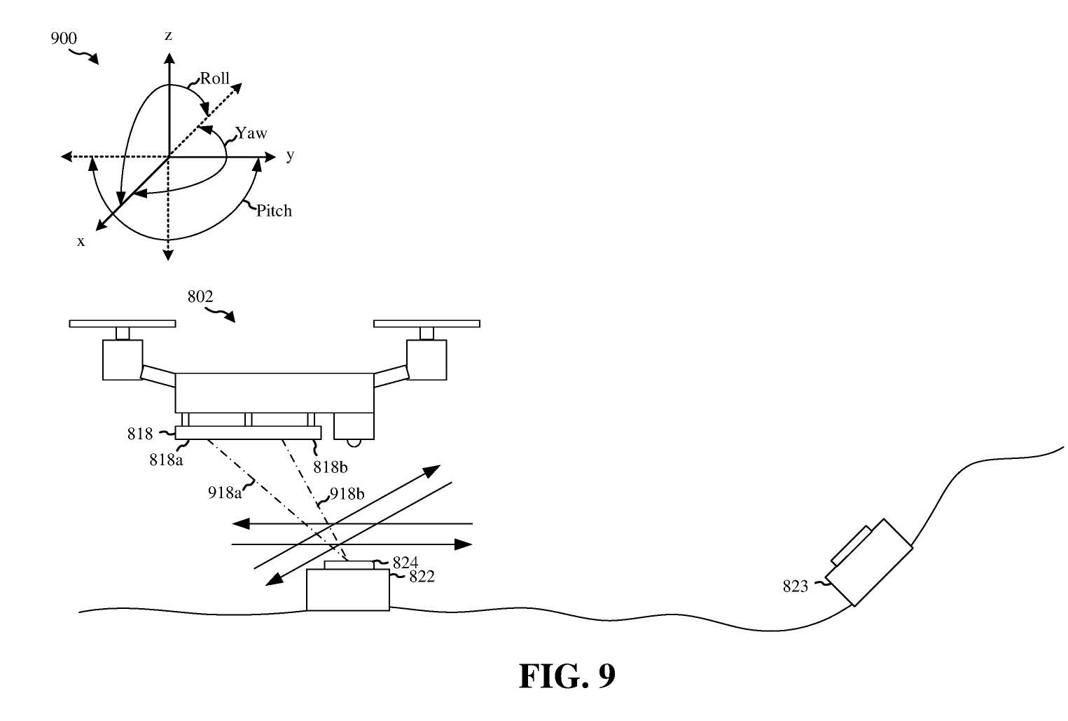

FIG. 9 is a diagram 900 illustrating an example of the apparatus 802 of FIG. 8 hovering at a location in proximity to a mapped location of the first wireless node 822 of one or more wireless nodes and determining an orientation of an antenna 824 of the first wireless node 822 with respect to an antenna of the apparatus. The apparatus 802 is shown executing a crisscross pattern of flight above the first wireless node 822; however, such a pattern of flight is not intended to be limiting. Any pattern of flight (including hovering) is within the scope of the disclosure. Moreover, the determination of the orientation of the antenna 824 of the first wireless node 822 may occur during the mapping of the first wireless node 822 or at a subsequent time. The apparatus 802 may use a visual technique (e.g., optical recognition or laser scanning of the antenna 824 of the first wireless node 822) to determine an orientation of an antenna 824 of the first wireless node 822. When using a visual technique, there may be a pattern, a marking, a physical structure or other visible object on the first wireless node 822, which allows the apparatus 802 to line-up a camera or a laser scanner mounted on the apparatus 802 with the visible object. The camera or laser scanner would be installed in a manner such that the orientation of the camera or laser scanner would be known relative to the external world, so that orienting the camera or laser scanner with respect to the first wireless node 822 would be equivalent to orienting the apparatus 802 with the first wireless node 822. Additionally, or alternatively, the apparatus 802 may use a SLAM technique to determine an orientation of an antenna 824 of the first wireless node 822. In some examples, SLAM is the computational problem of constructing and/or updating a map of an unknown environment while simultaneously keeping track of the location of the apparatus 802 within that map. In the SLAM technique, the apparatus 802 would map its environment, including the location and orientation of the first wireless node 822, using a plurality of sensors. Different types of sensors give rise to different SLAM algorithms as understood by those of skill in the art. Optical sensors may be one-dimensional (single beam) or 2D-(sweeping) laser rangefinders, 3D High Definition Light Detection and Ranging (LIDAR), 3D Flash LIDAR, 2D or 3D sonar sensors and one or more 2D cameras. Other forms of SLAM include radar SLAM and wifi-SLAM (sensing by strengths of nearby will access points). When the apparatus 802 is a drone, the apparatus 802 would fly in space to be mapped and collect data from its sensors to build a map of the environment. The location and orientation of objects, such as the first wireless node 822, and obstacles would be determined according to SLAM algorithms known to those of skill in the art. Additionally or alternatively, the apparatus 802 may use a radio frequency angle of arrival technique (e.g., a radar) to determine an orientation of an antenna 824 of the first wireless node 822. For example, using a radar technique, the angle of arrival of one or more pulses bounced off of, or emitted from, the first wireless node 822 may be calculated by the apparatus 802 and the orientation of the first wireless node 822 with respect to the apparatus 802 may be calculated. The apparatus 802 may then rotate itself in 6DoF to orient itself with the first wireless node 802 by, for example, rotating until the angle of arrival of the one or more pulses is calculated to be at a predetermined value. The predetermined value may indicate that the boresights of the antennas are aligned. Additionally or alternatively, the apparatus 802 may use a power measurement technique (e.g., using one or more antennas to measure received power from a beacon or signal transmitted from the first wireless node 822 and maximizing the received power until the boresights of the antennas are aligned) to determine an orientation of an antenna 824 of the first wireless node 822.

In one example, the antenna 818 of the apparatus 802 may be comprised of a plurality of sub-antennas. For simplicity, let the antenna 818 of the apparatus be comprised of a left antenna (818a) and a right antenna (818b). In one aspect, the left antenna 818a will be a certain distance and certain orientation with respect to the first wireless node 822 and the right antenna 818b will be at a different distance and different orientation with respect to the first wireless node 822. The different distances and orientations are depicted with reference to the dash-dot lines 918a and 918b, respectively. The signals received at the left and right antennas 818a, 818b will therefore be different and the apparatus can use the two different signals to determine an orientation of an antenna 824 of the first wireless node with respect to an antenna 818 of the apparatus 802. Accordingly, in some implementations the antenna 818 of the apparatus 802 is a plurality of antennas and determining an orientation of an antenna of the first wireless node with respect to an antenna of the apparatus comprises using differences of signals received at the plurality of antennas to determine the orientation of the antenna of the first wireless node with respect to the antenna of the apparatus. Additionally or alternatively, the apparatus 802 may use an optical technique and/or a SLAM technique to map the orientation of a body of first wireless node 822 and then use a compendium of information including the orientation of the antenna of each wireless node with respect to the orientation of the body of the wireless node to determine an orientation of an antenna 824 of the first wireless node 822. In one example, to determine the orientation: 1) the apparatus would have multiple antennas to facilitate a determination of angle of arrival from data/communication signals between the antennas of the apparatus and the antenna(s) of the sensor, 2) use the camera on the apparatus to identify keypoints on a patch antenna (or some target) of the sensor along with some sort of fly pattern of the apparatus 802 to be able to correlate accelerometer/global navigation satellite system (GNSS) values with the keypoints (i.e. SLAM algorithm) and along with the offset value of the antenna of the apparatus 802 relative to the camera of the apparatus 802 then determine the relative orientation, or 3) do a combination of both. These and other of ways to determine the orientation of an antenna 824 of the first wireless node 822 are within the scope of this disclosure. In some implementations, mapping, determining whether the apparatus is in proximity to the first wireless node of the one or more wireless nodes, and determining the orientation of the antenna of the first wireless node are performed using at least simultaneous localization and mapping (SLAM). In some implementations, the apparatus 802 may map a space including one or more locations of one or more wireless nodes 822, 823 and then establish a mapped location of a first wireless node 822 of the one or more wireless nodes 822, 823 based on the mapping. The apparatus 802 may then hover at a location in proximity to the mapped location of the first wireless node 822 and determine an orientation of an antenna 824 of the first wireless node 822 with respect to an antenna 818 of the apparatus 802.

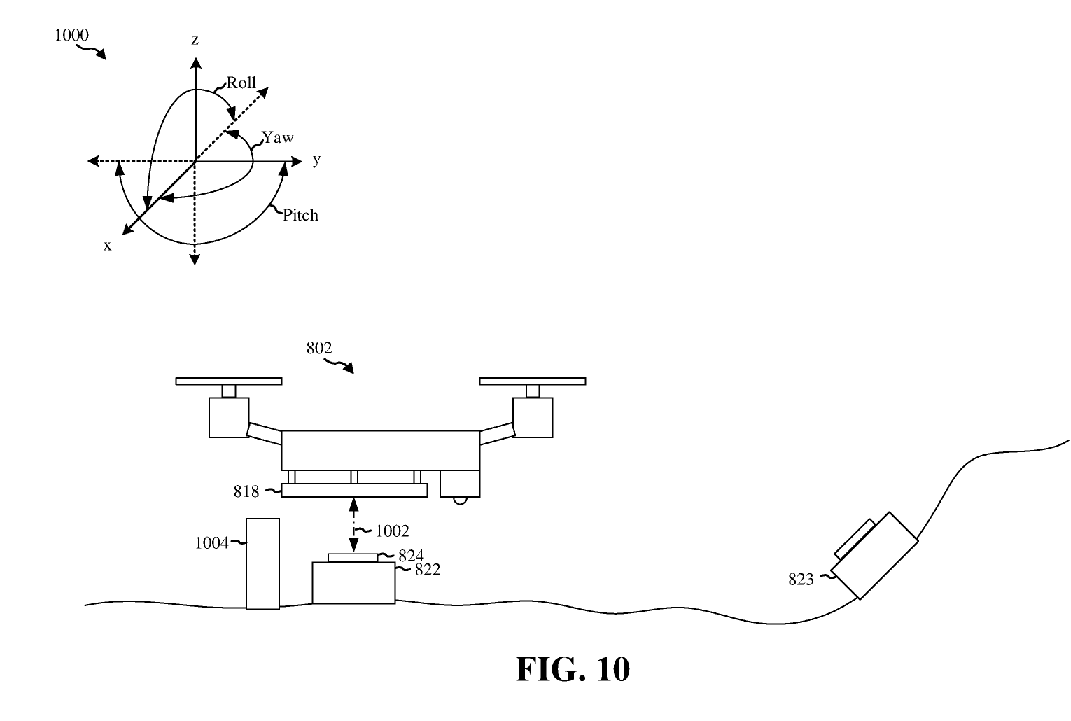

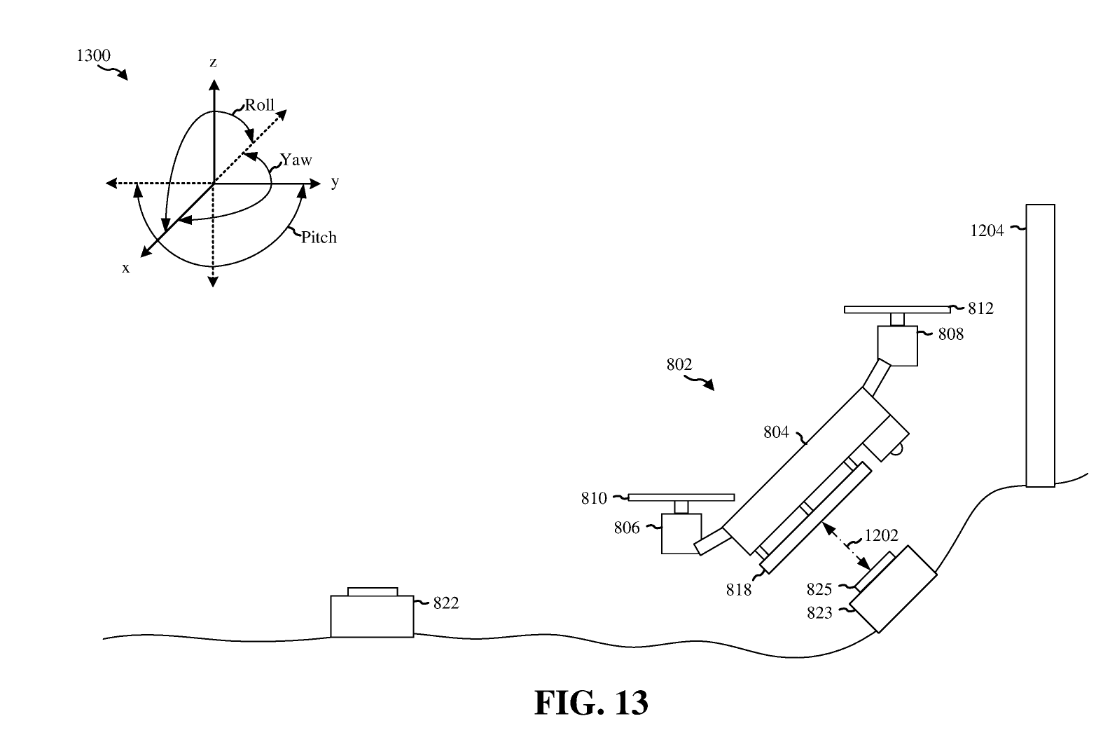

FIG. 10 is a diagram 1000 illustrating an example of the apparatus 802 of FIG. 8 aligning a boresight 1002 of an antenna 818 of the apparatus 802 with a boresight 1002 of an antenna 824 of the first wireless node 822. In other words, FIG. 10 is a diagram 1000 illustrating an example of the apparatus 802 of FIG. 8 aligning a maximum gain of an antenna 818 of the apparatus 802 with a maximum gain of an antenna 824 of the first wireless node 822. The apparatus 802 may establish a mapped location of the first wireless node 822 of the one or more wireless nodes 822, 823 based on a mapping and may hover at a location in proximity to the mapped location of the first wireless node 822. The apparatus 802 may determine an orientation of the antenna 824 of the first wireless node 822 with respect to the antenna 818 of the apparatus 802. In response to determining the orientation of the antenna 824 of the first wireless node 822, the apparatus 802 may align the antenna 818 of the apparatus 802 with the antenna 824 of the first wireless node 822, while maintaining the hover at the location. In other words, in response to determining the orientation of the antenna 824 of the first wireless node 822, the apparatus 802 may align the antenna 818 of the apparatus 802 with the antenna 824 of the first wireless node 822 by adjusting a six-degree-of-freedom (6DoF) orientation of the apparatus 802. The adjustment of the six-degree-of-freedom (6DoF) orientation of the apparatus 802 may involve translation of the apparatus 802 along the X, Y, and Z axes and further alignment of the orientation of the apparatus 802 in the pitch, roll, and yaw directions (with respect to the X, Y, and Z axes of the apparatus). It is noted that a helicopter (an air vehicle with a single horizontal propeller and a tail rotor) could not adjust a six-degree-of-freedom (6DoF) orientation of the apparatus 802 to align the antenna 818 of the apparatus 802 with the antenna 824 of the first wireless node 822, while maintaining the hover at the location because motion in at least the pitch and roll directions would move the helicopter away from the location. Known helicopters cannot be pitched while remaining in a hover at a given location or rolled while remaining in a hover at a given location (e.g. remaining stationary). In the case of the first wireless node 822, the antenna 824 is parallel to the ground so the antenna beam pattern (and boresight) of the antenna is at 90 degrees relative to the horizontal. The apparatus 802 therefore may maintain the antenna 818 of the apparatus 802 in a horizontal plane while translating the body of the apparatus along the X and Y axis until the boresights 1002 of the antennas 818, 824 are aligned. In the example of FIG. 10, the antenna 818 of the apparatus 802 is fixed to the apparatus 802 and adjusting the six-degree-of-freedom (6DoF) orientation of the apparatus 802, based on the orientation of the antenna 824 of the first wireless node 822, orients the apparatus 802 in yaw, pitch, or roll, or a combination thereof to increase a directional antenna gain of the antenna 818 of the apparatus 802 (e.g., to maximize the directional antenna gain) with respect to the orientation of the antenna 824 of the first wireless node 822 (where yaw, pitch, or roll, or a combination thereof may encompass yaw, pitch, roll, yaw and pitch, yaw and roll, pitch and roll, or yaw, pitch, and roll). In implementations where the apparatus 802 is a multi-propeller aerial vehicle, adjusting the six-degree-of-freedom (6DoF) orientation of the apparatus 802 may be performed by tilting propellers (e.g., individually or collectively) of the apparatus 802 relative to the body 804 (and therefore relative to the antenna 818) of the apparatus 802 (see, for example, FIG. 13). In some implementations, adjusting the six-degree-of-freedom (6DoF) orientation of the apparatus may be accomplished by individually changing the direction and/or speed of the propellers of the apparatus. In some implementations, adjusting the six-degree-of-freedom (6DoF) orientation of the apparatus may be accomplished by aligning an angle of maximum gain of the antenna 818 of the apparatus 802 with an angle of maximum gain of the antenna 824 of the first wireless node 822 based on the determined orientation of the antenna 824 of the first wireless node 822 and further comprises translating a position of the apparatus 802 in an X, Y, and Z direction toward the antenna of the first wireless node while avoiding obstacles 1004 adjacent to the first wireless node 822 (e.g., walls, posts, poles, stakes, pillars next to or grates, grills, lattices, trellises, vents covering the first wireless node 822). In this implementation, the apparatus 802 may travel along an axis of travel defined by the boresight 1010 of the antenna 818 of the apparatus 802 toward the antenna 824 of the first wireless node 822, thus maximizing the gain (e.g., utilizing the maximum gain) of the antenna 818 of the apparatus 802 while moving closer to the first wireless node 822.

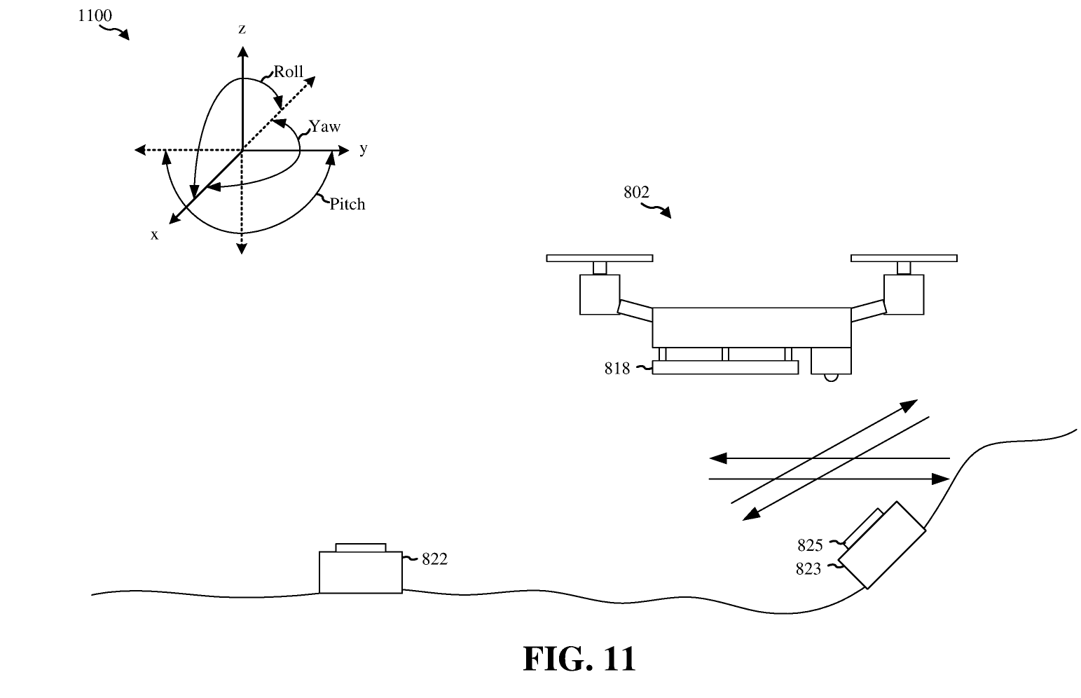

FIG. 11 is a diagram 1100 illustrating an example of the apparatus 802 of FIG. 8 hovering at a location in proximity to a mapped location of a second wireless node 823 of one or more wireless nodes and determining an orientation of an antenna 825 of the second wireless node 823 with respect to an antenna of the apparatus. The apparatus 802 is shown executing a crisscross pattern of flight above the second wireless node 823; however, such a pattern of flight is not intended to be limiting. Any pattern of flight (including hovering) is within the scope of the disclosure. Moreover, the determination of the orientation of the antenna 825 of the second wireless node 823 may occur during the mapping of the second wireless node 823 or at a subsequent time. The apparatus 802 may use a visual technique (e.g., optical recognition or laser scanning of the antenna 825 of the second wireless node 823) to determine an orientation of an antenna 825 of the second wireless node 823. Additionally, or alternatively, the apparatus 802 may use a SLAM technique to determine an orientation of an antenna 825 of the second wireless node 823. Additionally or alternatively, the apparatus 802 may use a radio frequency angle of arrival technique (e.g., a radar) to determine an orientation of an antenna 825 of the second wireless node 823. Additionally or alternatively, the apparatus 802 may use a power measurement technique (e.g., using one or more antennas to measure received power from a beacon or signal transmitted from the second wireless node 823 and maximizing the received power until the boresights of the antennas are aligned) to determine an orientation of an antenna 825 of the second wireless node 823. Additionally or alternatively, the apparatus 802 may use an optical technique and/or a SLAM technique to map the orientation of a body of second wireless node 823 and then use a compendium of information including the orientation of the antenna of each wireless node with respect to the orientation of the body of the wireless node to determine an orientation of an antenna 825 of the second wireless node 823. These and other of ways to determine the orientation of an antenna 825 of the second wireless node 823 are within the scope of this disclosure.

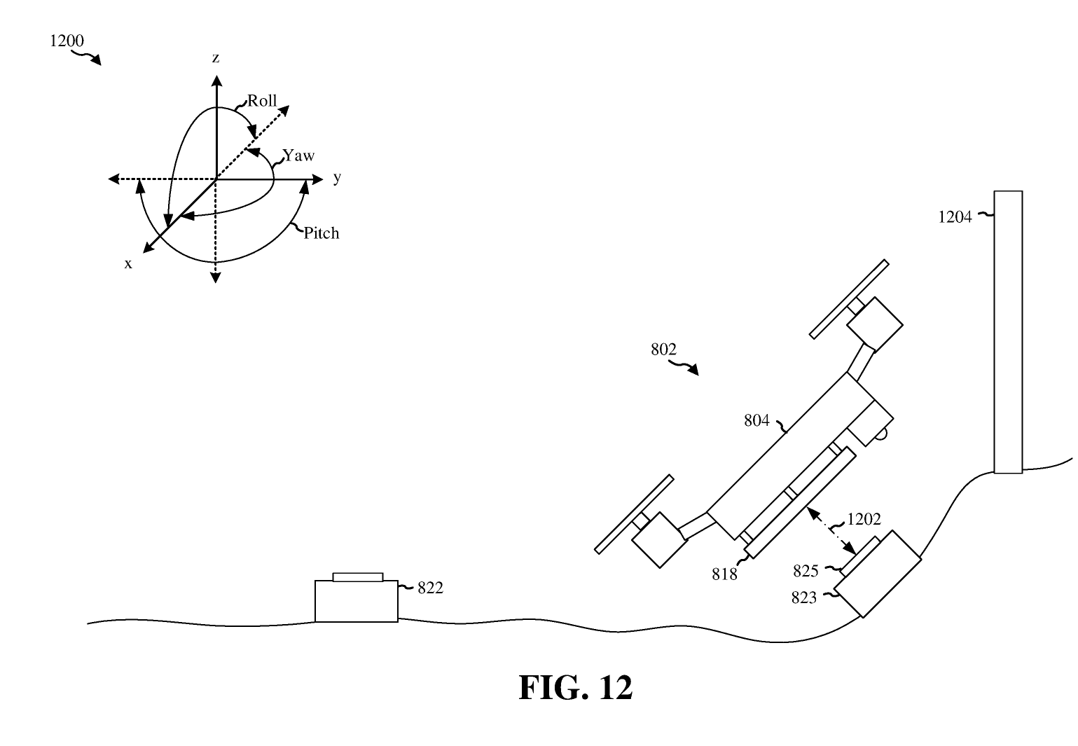

FIG. 12 is a diagram 1200 illustrating an example of the apparatus 802 of FIG. 8 aligning a boresight 1202 of an antenna 818 of the apparatus 802 with a boresight 1202 of an antenna 825 of the second wireless node 823. In other words, FIG. 12 is a diagram 1200 illustrating an example of the apparatus 802 of FIG. 8 aligning a maximum gain of an antenna 818 of the apparatus 802 with a maximum gain of an antenna 825 of the second wireless node 823. The apparatus 802 may establish a mapped location of the second wireless node 823 of the one or more wireless nodes 822, 823 based on a mapping and may hover at a location in proximity to the mapped location of the second wireless node 823. By way of example, a multi-propeller apparatus having six or more non-tilting propellers, or eight or more non-tilting propellers, could achieve the orientation depicted in FIG. 12 based on individual control of the speed and direction of the propellers. The apparatus 802 may determine an orientation of the antenna 825 of the second wireless node 823 with respect to the antenna 818 of the apparatus 802. In response to determining the orientation of the antenna 825 of the second wireless node 823, the apparatus 802 may adjust a six-degree-of-freedom (6DoF) orientation of the apparatus 802 to align the antenna 818 of the apparatus 802 with the antenna 825 of the second wireless node 823, while maintaining the hover at the location. The adjustment of the six-degree-of-freedom (6DoF) orientation of the apparatus 802 may involve translation of the apparatus 802 along the X, Y, and Z axes and further alignment of the orientation of the apparatus 802 (e.g., the body 804 of the apparatus 802) in the pitch, roll, and yaw directions (with respect to the X, Y, and Z axes of the apparatus). It is noted that a helicopter (an air vehicle with a single horizontal propeller and a tail rotor) could not adjust a six-degree-of-freedom (6DoF) orientation of the apparatus 802 to align the antenna 818 of the apparatus 802 with the antenna 825 of the second wireless node 823, while maintaining the hover at the location because motion in at least the pitch and roll directions would move the helicopter away from the location. Known helicopters cannot be pitched and remain stationary or rolled and remain stationary (e.g., hovering at a given location). In the case of the second wireless node 823, the antenna 825 is oriented at 45 degrees relative to the horizontal so the antenna beam pattern (and boresight 1202) of the antenna 825 is at 45 degrees relative to the horizontal. The apparatus 802 therefore may adjust the orientation of the body 804 of the apparatus 802 to maintain the antenna 818 of the apparatus 802 in a plane that is at 45 degrees relative to the horizontal (by adjusting the pitch, roll, and yaw of the apparatus 802) while translating the body 804 of the apparatus 802 along the X, Y, and Z axes until the boresights 1202 of the antennas 818, 825 are aligned. In other words, the apparatus 802 may be oriented in at least one of yaw, pitch, or roll (i.e., in yaw, pitch, roll, or a combination thereof) to increase a directional antenna gain of the antenna 818 of the apparatus 802 with respect to the orientation of the antenna 825 of the second wireless node 823. In the example of FIG. 12, the antenna 818 of the apparatus 802 is fixed to the apparatus 802 and adjusting the six-degree-of-freedom (6DoF) orientation of the apparatus 802, based on the orientation of the antenna 825 of the second wireless node 823, orients the apparatus 802 in at least one of yaw, pitch, or roll to increase a directional antenna gain of the antenna 818 of the apparatus 802 with respect to the orientation of the antenna 825 of the second wireless node 823. In implementations where the apparatus 802 is a multi-propeller aerial vehicle, adjusting the six-degree-of-freedom (6DoF) orientation of the apparatus 802 may be performed by tilting propellers (e.g., individually or collectively) of the apparatus 802 relative to the body 804 (and therefore relative to the antenna 818) of the apparatus 802 (see, for example, FIG. 13). In some implementations, adjusting the six-degree-of-freedom (6DoF) orientation of the apparatus may be accomplished by individually changing the direction and/or speed of the propellers of the apparatus. In some implementations, adjusting the six-degree-of-freedom (6DoF) orientation of the apparatus 802 may be accomplished by aligning an angle of maximum gain of the antenna 818 of the apparatus 802 with an angle of maximum gain of the antenna 825 of the second wireless node 823 based on the determined orientation of the antenna 825 of the second wireless node 823 and translating a position of the apparatus 802 in an X, Y, and Z direction toward the antenna 825 of the second wireless node 823 while avoiding obstacles 1204 adjacent to the second wireless node 823 (e.g., walls, posts, poles, stakes, pillars next to or grates, grills, lattices, trellises, vents covering the second wireless node 823). In this implementation, the apparatus 802 may travel along an axis of travel defined by the boresight 1202 of the antenna 818 of the apparatus 802 toward the antenna 825 of the second wireless node 823, thus maximizing the gain (e.g., utilizing the maximum gain) of the antenna 818 of the apparatus 802 while moving closer to the second wireless node 823.

FIG. 13 is a diagram 1300 illustrating an example of the apparatus 802 of FIG. 8 aligning a boresight 1202 of an antenna 818 of the apparatus 802 with a boresight 1202 of an antenna 825 of the second wireless node 823. In other words, FIG. 13 is a diagram 1300 illustrating an example of the apparatus 802 of FIG. 8 aligning a maximum gain of an antenna 818 of the apparatus 802 with a maximum gain of an antenna 825 of the second wireless node 823. The apparatus 802 may establish a mapped location of the second wireless node 823 of the one or more wireless nodes 822, 823 based on a mapping of the space performed by the apparatus and may hover at a location in proximity to the mapped location of the second wireless node 823. The apparatus 802 may determine an orientation of the antenna 825 of the second wireless node 823 with respect to the antenna 818 of the apparatus 802. In the example of FIG. 13, the antenna 818 of the apparatus 802 is fixed to the apparatus 802 and adjusting the six-degree-of-freedom (6DoF) orientation of the apparatus 802, based on the orientation of the antenna 825 of the second wireless node 823, orients the apparatus 802 in at least one of yaw, pitch, or roll to increase a directional antenna gain of the antenna 818 of the apparatus 802 with respect to the orientation of the antenna of the second wireless node. In response to determining the orientation of the antenna 825 of the second wireless node 823, the apparatus 802 may adjust a six-degree-of-freedom (6DoF) orientation of the apparatus 802 to align the antenna 818 of the apparatus 802 with the antenna 825 of the second wireless node 823, while maintaining the hover at the location. In the example as implemented in FIG. 13, the apparatus 802 is a multi-propeller aerial vehicle and adjusting the six-degree-of-freedom (6DoF) orientation of the apparatus 802 may be performed by tilting propellers 810, 812 of the apparatus 802 relative to the body 804 (and therefore relative to the antenna 818) of the apparatus 802. It is noted that the propellers 810, 812 of the apparatus 802 do not have to tilt at the same angles or even in the same direction. In some implementations, adjusting the six-degree-of-freedom (6DoF) orientation of the apparatus 802 may be accomplished by aligning an angle of maximum gain of the antenna 818 of the apparatus 802 with an angle of maximum gain of the antenna 825 of the second wireless node 823 based on the determined orientation of the antenna 825 of the second wireless node 823 and translating a position of the apparatus 802 in an X, Y, and Z direction toward the antenna 825 of the second wireless node 823 while avoiding obstacles 1204 adjacent to the second wireless node 823 (e.g., walls, posts, poles, stakes, pillars next to or grates, grills, lattices, trellises, vents covering the second wireless node 823). In this implementation, the apparatus 802 may travel along an axis of travel defined by the boresight 1202 of the antenna 818 of the apparatus 802 toward the antenna 825 of the second wireless node 823, thus maximizing the gain (e.g., utilizing the maximum gain) of the antenna 818 of the apparatus 802 while moving closer to the second wireless node 823. It is noted that a helicopter (an air vehicle with a single horizontal propeller and a tail rotor) could not adjust a six-degree-of-freedom (6DoF) orientation of the apparatus 802 to align the antenna 818 of the apparatus 802 with the antenna 825 of the second wireless node 823, while maintaining the hover at the location because motion in at least the pitch and roll directions would move the helicopter away from the location. Known helicopters cannot be pitched while remaining in a hover at a given location or rolled while remaining in a hover at a given location (e.g. remaining stationary).

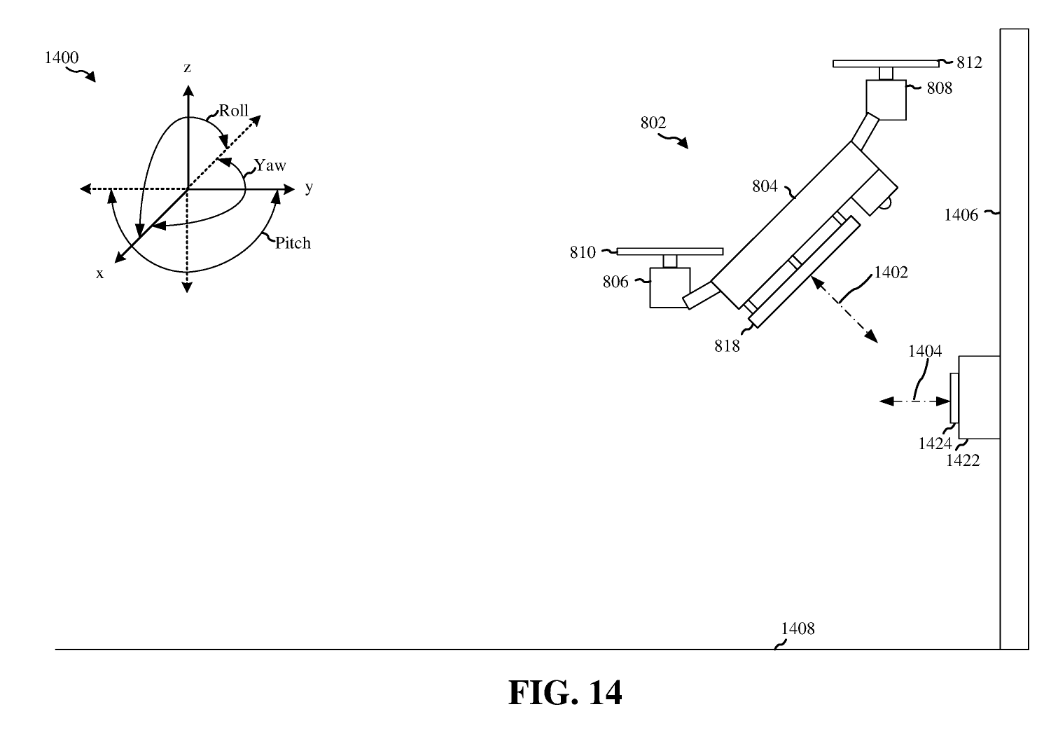

FIG. 14 is a diagram 1400 illustrating an example of the apparatus 802 of FIG. 8 aligning a boresight 1402 of an antenna 818 of the apparatus 802 as close as possible with a boresight 1404 of an antenna 1424 of the wireless node 1422. In other words, FIG. 14 is a diagram 1400 illustrating an example of the apparatus 802 of FIG. 8 aligning a maximum gain of an antenna 818 of the apparatus 802 as close as possible with a maximum gain of an antenna 1424 of the wireless node 1422. Wireless nodes have been described herein and a complete description of the wireless node 1422 of FIG. 14 will therefore not be presented to avoid duplication. It will be noted that wireless node 1422 is mounted to a wall or post 1406 in the illustration of FIG. 14. In this orientation, the boresight 1404 of the antenna 1424 of the wireless node 1422 may be parallel to a horizontal plane (e.g., a floor 1408). It may not be possible to align the boresight 1402 of the antenna 818 of the apparatus 802 with the boresight 1404 of the antenna 1424 of the wireless node 1422 such that both boresights are substantially pointing at one another along the same axis. Nevertheless, the orientation of the apparatus 802 may be adjusted to increase the power transferred from the apparatus 802 to the wireless node 1422 (e.g., to maximize the power transferred). Therefore, in response to determining that the apparatus 802 is in proximity to the wireless node 1422 and determining the orientation of the antenna 1424 of the wireless node 1422, the apparatus 802 may adjust a six-degree-of-freedom (6DoF) orientation of the apparatus 802, based on the determined orientation of the antenna 1424 of the wireless node 1422. The adjustment of the six-degree-of-freedom (6DoF) orientation of the apparatus 802 may involve translation of the apparatus 802 along the X, Y, and Z axes and further alignment of the orientation of the apparatus 802 (e.g., the body 804 of the apparatus 802) in the pitch, roll, and yaw directions (with respect to the apparatus). In the case of the wireless node 1422 of FIG. 14, the antenna 1424 is oriented at 90 degrees relative to the horizontal so the antenna beam pattern (and boresight 1404) of the antenna 1424 is at zero degrees relative to the horizontal. The apparatus 802 therefore may adjust the orientation of the body 804 of the apparatus 802 to maintain the antenna 818 of the apparatus 802 in a plane that is as close to 90 degrees relative to the horizontal (by adjusting the pitch, roll, and yaw of the apparatus 802) as possible. In the illustration of FIG. 14, the apparatus 802 has adjusted the orientation of the body 804 of the apparatus 802 to approximately 45 degrees relative to the horizontal. Other implementations of apparatus may adjust the orientation of the apparatus (and therefore the orientation of the antenna of the apparatus) to angles that are more or less than 45 degrees relative to the horizontal without departing from the scope of the disclosure. Even if the apparatus 802 slightly tilts its antenna 818 toward the antenna 1424 of the wireless node 1422, this will be a great improvement in power transfer (and/or communication reliability) between the apparatus 802 and the wireless node 1422 in comparison to implementations where the antenna of the apparatus cannot be tilted. The apparatus 802 may maintain the antenna 818 of the apparatus 802 in a plane that is as close to 90 degrees relative to the horizontal as possible (by adjusting the pitch, roll, and yaw of the apparatus 802), while translating the body 804 of the apparatus 802 along the X, Y, and Z axes until the boresights 1402, 1404 of the antennas 818, 1424 are aligned as closely as possible. In the example of FIG. 14, the antenna 818 of the apparatus 802 is fixed to the apparatus 802 and adjusting the six-degree-of-freedom (6DoF) orientation of the apparatus 802, based on the orientation of the antenna 1424 of the wireless node 1422, orients the apparatus 802 in at least one of yaw, pitch, or roll to increase a directional antenna gain of the antenna 818 of the apparatus 802 with respect to the orientation of the antenna 1424 of the wireless node 1422. In implementations where the apparatus 802 is a multi-propeller aerial vehicle (as shown in FIG. 14), adjusting the six-degree-of-freedom (6DoF) orientation of the apparatus 802 may be performed by tilting propellers 810, 812 of the apparatus 802 relative to the body 804 (and therefore relative to the antenna 818) of the apparatus 802. In some implementations, adjusting the six-degree-of-freedom (6DoF) orientation of the apparatus 802 may be accomplished by aligning an angle of maximum gain of the antenna 818 of the apparatus 802 as closely as possible to an angle of maximum gain of the antenna 1424 of the wireless node 1422 based on the determined orientation of the antenna 1424 of the wireless node 1422 and translating a position of the apparatus 802 in an X, Y, and Z direction toward the antenna 1424 of the wireless node 1422 while avoiding obstacles 1206 adjacent to the wireless node 1422 (e.g., walls, posts, poles, stakes, pillars next to or grates, grills, lattices, trellises, vents covering the wireless node 1422). In this implementation, the apparatus 802 may travel along an axis of travel defined by the boresight 1402 of the antenna 818 of the apparatus 802 toward the antenna 1424 of the wireless node 1422, thus maximizing the gain (e.g., utilizing the maximum gain) of the antenna 818 of the apparatus 802 while moving closer to the wireless node 1422.

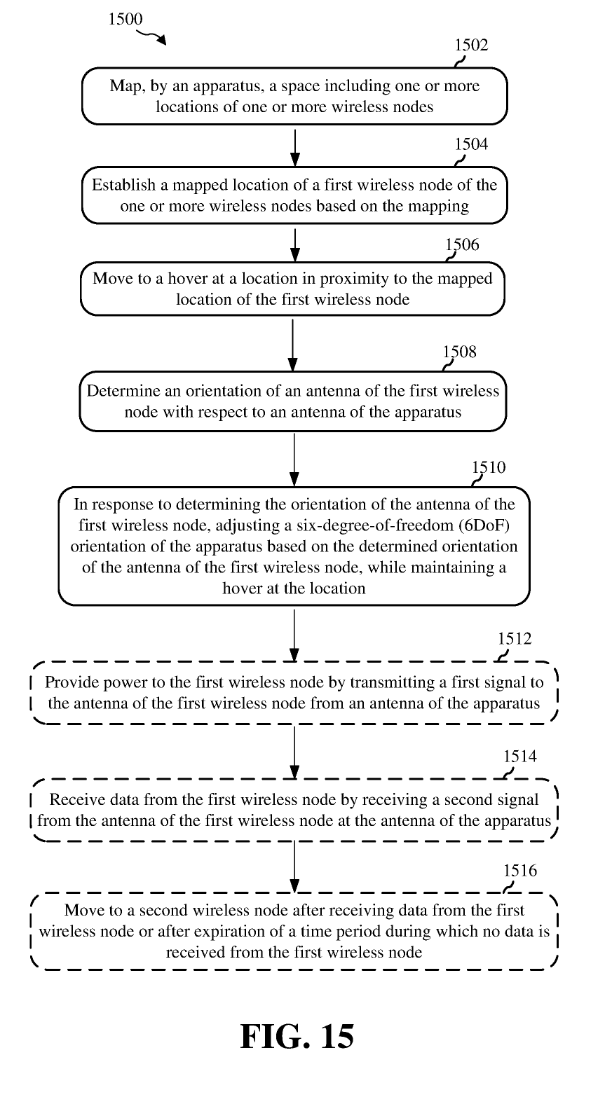

FIG. 15 is a diagram 1500 illustrating an example of various methods and/or processes operable at an apparatus. Such an apparatus may be the apparatus 102 described above with reference to FIGS. 1-3, the apparatus 402 described above with reference to FIGS. 4-6, and/or the apparatus 802 described above with references to FIGS. 8-14. At block 1502, the apparatus may map a space including one or more locations of one or more wireless nodes. For example, referring to FIG. 8, the apparatus 802 may fly in a pattern 826 in space, in order to map the space, where the space includes one or more locations of one or more wireless nodes 822, 823. The space may be a predefined space. In some implementations, the space may be bounded by predesignated geographic limits and/or physical obstacles. The boundaries of the space may be identified based on latitude, longitude, and altitude coordinates and may be determined, for example, by an on-board GPS, GIS, RTK, and/or inertial navigation system. The one or more locations of one or more wireless nodes may be mapped by the apparatus using, for example, optical recognition, radar, sonar, laser scanning, laser range finding, and/or SLAM. Other methods of mapping the space are within the scope of the disclosure.

In some configurations, at block 1504, the apparatus may establish a mapped location of a first wireless node of the one or more wireless nodes based on the mapping.

In some configurations, at block 1506, the apparatus may hover at a location in proximity to the mapped location of the first wireless node.

In some configurations, at block 1508, the apparatus may determine an orientation of an antenna of the first wireless node with respect to an antenna of the apparatus. For example, referring to FIG. 9, the apparatus 102 may fly in a pattern over the first wireless node 822 to determine the orientation of the antenna 824 of the first wireless node 822 with respect to an antenna 818 of the apparatus 802. Flying the pattern may include hovering over the first wireless node 822 if the apparatus is an aerial vehicle that has an ability to hover, or pausing over the first wireless node 822 if the apparatus is a terrestrial vehicle. Determine an orientation of an antenna of the first wireless node with respect to an antenna of the apparatus may be accomplished, for example, by optical recognition, laser scanning, simultaneous localization and mapping (SLAM), radio frequency angle of arrival, and/or power measurement of the antenna(s) of the first wireless node. Other methods of determining an orientation of an antenna of the first wireless node with respect to an antenna of the apparatus are within the scope of the disclosure.

In some configurations, at block 1510, in response to determining the orientation of the antenna of the first wireless node, the apparatus may adjust a six-degree-of-freedom (6DoF) orientation of the apparatus to align the antenna of the apparatus with the antenna of the first wireless node, while maintaining the hover at the location. For example, referring to FIG. 10, the adjustment may be affected in order to increase the gain of the antenna 818 of the apparatus 802, by pointing the boresight 1002 (e.g., angle of maximum gain) of the antenna 818 of the apparatus 802 as close as possible to the boresight 1002 of the antenna 824 of the wireless node 822. By way of another example, referring to FIG. 12, the adjustment may be made in order to increase the gain of the antenna 818 of the apparatus 802, by pointing the boresight 1202 (e.g., angle of maximum gain) of the antenna 818 of the apparatus 802 as close as possible to the boresight 1202 of the antenna 824 of the wireless node 822. By way of still another example, referring to FIG. 14, the adjustment may be made in order to increase the gain of the antenna 818 of the apparatus 802, by pointing the boresight 1402 (e.g., angle of maximum gain) of the antenna 818 of the apparatus 802 as close as possible to the boresight 1404 of the antenna 1424 of the wireless node 1422, even though the two boresights 1402, 1404 could not be aligned along the same axis. Accordingly, when the antenna 818 of the apparatus 802 is fixed to the apparatus 802, adjusting the six-degree-of-freedom (6DoF) orientation of the apparatus 802, based on the orientation of the antenna of a wireless node 822, 823, 1422, orients the apparatus 802 in at least one of yaw, pitch, or roll to increase a directional antenna gain of the antenna 818 of the apparatus 802 (e.g., to maximize the directional antenna gain) with respect to the orientation of the antenna of the wireless node 822, 823, 1422. Additionally, when the apparatus 802 is a multi-propeller aerial vehicle, adjusting the six-degree-of-freedom (6DoF) orientation of the apparatus 802 may be performed by tilting propellers of the apparatus 802 relative to the body 804 (and therefore relative to the antenna 818) of the apparatus 802. Still further, the feature of adjusting the six-degree-of-freedom (6DoF) orientation of the apparatus may be accomplished by aligning an angle of maximum gain of the antenna 818 of the apparatus 802 with an angle of maximum gain of the antenna 824, 825, 1424 of the wireless node 822, 823, 1422 based on the determined orientation of the antenna 824, 825, 1424 of the wireless node and translating a position of the apparatus 802 in an X, Y, and Z direction toward the antenna 824, 825, 1424 of the wireless node 822, 823, 1422 while avoiding obstacles adjacent to the wireless node 822, 823, 1422.

In some configurations, at block 1512, the apparatus may optionally provide power to the first wireless node by transmitting a signal to the antenna of the first wireless node from an antenna of the apparatus. For example, referring to FIGS. 10, 12, 13, and 14, once the six-degree-of-freedom (6DoF) orientation of the apparatus 802 is adjusted based on the determined orientation of the antenna of the wireless node, power may be provided to the wireless node by transmitting a first signal to the antenna of the wireless node from the antenna of the apparatus. The transmission of power would be in the direction indicated by the arrowhead pointing from the antenna 818 of the apparatus 802 toward the antenna of the wireless node.

In some configurations, at block 1514, the apparatus may optionally receive data from the first wireless node by receiving a signal from the antenna of the first wireless node at the antenna of the apparatus. For example, referring to FIGS. 10, 12, 13, and 14, once the six-degree-of-freedom (6DoF) orientation of the apparatus 802 is adjusted based on the determined orientation of the antenna of the wireless node, the apparatus may optionally receive data from the wireless node by receiving a second signal from the antenna of the wireless node at the antenna 818 of the apparatus 802. The reception of data would be in the direction indicated by the arrowhead pointing toward the antenna 818 of the apparatus 802 from the antenna of the wireless node.

In some configurations, at block 1516, the apparatus may optionally move to a second wireless node after receiving data from the first wireless node or after expiration of a time period during which no data is received from the first wireless node. For example, referring to FIG. 10, the apparatus 802 may move to the second wireless node 823 after expiration of a time period during which no data is received from the first wireless node 822. For example, in some circumstances, the first wireless node 822 may be inoperable and therefore not transmitting data. After waiting for a period of time, the apparatus 802 may move to another wireless node (e.g., the adjacent wireless node 823). By moving to another wireless node (e.g., the adjacent wireless node 823), the apparatus 802 minimizes the likelihood of wasting time and power on attempting to collect data from a wireless node that is inoperable.

The methods and/or processes described with reference to FIG. 15 are provided for illustrative purposes and are not intended to limit the scope of the present disclosure. The methods and/or processes described with reference to FIG. 15 may be performed in sequences different from those illustrated therein without deviating from the scope of the present disclosure. Additionally, some or all of the methods and/or processes described with reference to FIG. 15 may be performed individually and/or together without deviating from the scope of the present disclosure. It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

FIG. 16 is a diagram 1600 illustrating an example of a hardware implementation of a processing system of an apparatus. Such an apparatus may be the same as or different from the apparatus 102, 402, 802 described above with reference to FIGS. 1-15 without deviating from the scope of the present disclosure. In some configurations, the processing system 1602 may include a user interface 1612. The user interface 1612 may be configured to receive one or more inputs from a user of the processing system 1602. The user interface 1612 may also be configured to display information to the user of the processing system 1602. The user interface 1612 may exchange data to and/or from the processing system 1602 via the bus interface 1608. The processing system 1602 may also include a transceiver 1610. The transceiver 1610 may be configured to transmit a signal used to power a wireless node (e.g., transmit power wirelessly via a radio frequency signal). The transceiver 1610 may be configured to receive data and/or transmit data in communication with another apparatus, such as a wireless node. The transceiver 1610 provides a means for transmitting power to a wireless node via a wired and/or wireless transmission medium. The transceiver 1610 may also provide a means for communicating with another apparatus (e.g., a wireless node) via a wired and/or wireless transmission medium. The transceiver 1610 may be configured to perform such power transfer and/or communications using various types of technologies. One of ordinary skill in the art will understand that many types of technologies to perform such power transfer and/or communication may be used without deviating from the scope of the present disclosure. The processing system 1602 may also include a memory 1614, one or more processors 1604, a computer-readable medium 1606, and a bus interface 1608. The bus interface 1608 may provide an interface between a bus 1603 and the transceiver 1610. The memory 1614, the one or more processors 1604, the computer-readable medium 1606, and the bus interface 1608 may be connected together via the bus 1603. The processor 1604 may be communicatively coupled to the transceiver 1610 and/or the memory 1614.

The processor 1604 may include a positioning circuit 1620, a power circuit 1621, a wireless node/sensor circuit 1622, an extension circuit 1623, a mapping circuit 1624, an antenna orientation circuit 1625, and/or other circuits (not shown). Generally, the positioning circuit 1620, the power circuit 1621, the wireless node/sensor circuit 1622, the extension circuit 1623, the mapping circuit 1624, the antenna orientation circuit 1625, and/or other circuits (not shown) may, individually or collectively, include various hardware components and/or software modules that can perform and/or enable any one or more of the functions, methods, operations, processes, features and/or aspects described herein with reference to an apparatus. The positioning circuit 1620 may be configured to determine to position an apparatus in proximity to a POI and/or to determine whether the apparatus is in proximity to a wireless node. In some configurations, the positioning circuit 1620 may be configured to determine to position the apparatus in proximity to a wireless node located at the POI. Such determinations may be performed according to various technologies, as described in greater detail above. Accordingly, the positioning circuit 1620 provides a means for positioning an apparatus in proximity to the POI and/or a means for determining whether the apparatus is in proximity to a wireless node of one or more wireless nodes in accordance with various aspects of the present disclosure. In some configurations, the positioning circuit 1620 may be configured to at least partially submerge a sensor below ground.

The power circuit 1621 may be configured to provide power to a wireless node that may include a sensor. Power may be provided via the extension portion of the apparatus and/or via an antenna of the apparatus. In some configurations, the power circuit 1621 may be configured to provide the power to the wireless node that may include the sensor via a wired connection and/or a wireless connection according to various parameters, as described in greater detail above. Accordingly, the power circuit 1621 provides the means for providing power to a wireless node that may include a sensor. Providing the power may be accomplished via the extension portion of the apparatus or via wireless transmission of a signal to the wireless node. Additionally, the power circuit 1621 may provide the means for providing power to the first wireless node by transmitting a signal to the antenna of the first wireless node from an antenna of the apparatus in accordance with various aspects of the disclosure described herein.

The wireless node/sensor circuit 1622 may be configured to receive data from the sensor via the extension portion of the apparatus and/or via an antenna of the apparatus. Such reception may be performed utilizing the transceiver 1610. In some configurations, the wireless node/sensor circuit 1622 may be configured to receive data from the wireless node/sensor via the extension portion of the apparatus via a wired connection and/or a wireless connection according to various parameters, as described in greater detail above. Accordingly, the wireless node/sensor circuit 1622 provides the means for receiving data from the wireless node/sensor via the extension portion of the apparatus. Additionally, the wireless node/sensor circuit 1622 provides the means for receiving data from the first wireless node by receiving a signal from the antenna of the first wireless node at the antenna of the apparatus. Additionally, the wireless node/sensor circuit 1622 provides the means for moving to a second wireless node after receiving data from the first wireless node or after expiration of a time period during which no data is received from the first wireless node. Additionally, the wireless node/sensor circuit 1622 may provide the means for hovering at a location in proximity to the mapped location of the first wireless node in accordance with various aspects of the present disclosure.

The extension circuit 1623 may be configured to move, extend, and/or retract the extension portion of the apparatus in accordance with various aspects of the present disclosure. In some configurations, the extension circuit 1623 may be configured to determine to move the extension portion of the apparatus further towards the POI after positioning the apparatus in proximity to the POI. In some configurations, the extension circuit 1623 may be configured to utilize an attractant (e.g., a magnet) to form a wired connection between the extension portion of the apparatus and the wireless node (and/or sensor of the wireless node). In some configurations, the extension circuit 1623 may be configured to determine to retract the extension portion of the apparatus after receiving the data from the wireless node (and/or sensor of the wireless node) or after expiration of a time period during which no data is received from the wireless node (and/or sensor of the wireless node). Accordingly, the extension circuit 1623 provides the means for extending and/or retracting the extension portion of the apparatus in accordance to various aspects of the present disclosure.

The mapping circuit 1624 may be configured to map a space including one or more locations of one or more wireless nodes. In some implementations, the mapping may be performed by the apparatus flying in a pattern within the space to identify landmarks within the space, the landmarks including the one or more wireless nodes. Accordingly, the mapping circuit 1624 may provide the means for mapping, by the apparatus, a space including one or more locations of one or more wireless nodes in accordance to various aspects of the present disclosure. The mapping circuit 1624 may further be configured to establish a mapped location of a first wireless node of the one or more wireless nodes based on the mapping. Accordingly, the mapping circuit 1624 may provide the means for establishing a mapped location of a first wireless node of the one or more wireless nodes based on the mapping. The antenna orientation circuit 1625 may be configured to determine an orientation of an antenna of a wireless node with respect to an antenna of the apparatus. For example, the orientation of the antenna of the wireless node may be determined after mapping of the location of the wireless node and after the apparatus is determined to be in proximity to the wireless node. In some implementations, determining the orientation of the antenna of the wireless node may be performed using at least one of optical recognition, laser scanning, simultaneous localization and mapping (SLAM), radio frequency angle of arrival, or power measurement of the antenna(s) of the first wireless node. The antenna orientation circuit 1625 may be configured according to these and any other techniques. Accordingly, the antenna orientation circuit 1625 may be the means for determining an orientation of an antenna of a wireless node with respect to an antenna of the apparatus in accordance with various aspects of the present disclosure. The antenna orientation circuit 1625 may also be configured to, in response to determining the orientation of the antenna of the first wireless node, adjusting a six-degree-of-freedom (6DoF) orientation of the apparatus to align the antenna of the apparatus with the antenna of the first wireless node, while maintaining a hover at the location (e.g., the location in proximity to the mapped location of the first wireless node). For example, in an implementation where the antenna of the apparatus is fixed to the apparatus, the antenna orientation circuit 1625 may be configured to adjust the six-degree-of-freedom (6DoF) orientation of the apparatus, based on the orientation of the antenna of the first wireless node, to orient the apparatus in at least one of yaw, pitch, or roll to increase a directional antenna gain of the antenna of the apparatus (e.g., to maximize the directional antenna gain) with respect to the orientation of the antenna of the first wireless node. In another implementation, the apparatus may be a multi-propeller aerial vehicle and adjusting the six-degree-of-freedom (6DoF) orientation of the apparatus may be performed by configuring the antenna orientation circuit to tilt propellers of the apparatus relative to the antenna of the apparatus. In another implementation, where adjusting the six-degree-of-freedom (6DoF) orientation of the apparatus may be accomplished by configuring the antenna orientation circuit 1625, adjusting the six-degree-of-freedom (6DoF) orientation of the apparatus may be accomplished by aligning an angle of maximum gain of the antenna of the apparatus with an angle of maximum gain of the antenna of the wireless node based on the determined orientation of the antenna of the wireless node and translating a position of the apparatus in an X, Y, and Z direction toward the antenna of the wireless node while avoiding obstacles adjacent to the wireless node. Accordingly, the antenna orientation circuit 1625 may be the means for, in response to determining the orientation of the antenna of the wireless node, adjusting a six-degree-of-freedom (6DoF) orientation of the apparatus to align the antenna of the apparatus with the antenna of the first wireless node, while maintaining the hover at the location in accordance to various aspects of the present disclosure. In other words, the antenna orientation circuit 1625 may be the means for adjusting a six-degree-of-freedom (6DoF) orientation of the apparatus based on the determined orientation of the antenna of the wireless node in accordance to various aspects of the present disclosure. Additionally, the antenna orientation circuit 1625 may be the means for orienting the apparatus in at least one of yaw, pitch, or roll to increase a directional antenna gain of the antenna of the apparatus with respect to the orientation of the antenna of the first wireless node, the means for tilting propellers of the apparatus relative to the body (and therefore relative to the antenna) of the apparatus, and/or the means for translating a position of the apparatus in an X, Y, and Z direction toward the antenna of the first wireless node while avoiding obstacles adjacent to the first wireless node.

The foregoing description provides a non-limiting example of the processor 1604 of the processing system 1602. Although various circuits have been described above, one of ordinary skill in the art will understand that the processor 1604 may also include various other circuits (not shown) that are in addition and/or alternative(s) to circuits 1620, 1621, 1622, 1623, 1624, 1625 described above. Such other circuits (not shown) may provide the means for performing any one or more of the functions, methods, operations, processes, features and/or aspects described herein with reference to the apparatus.

The computer-readable medium 1606 includes various computer executable instructions. The computer-executable instructions may be executed by various hardware components (e.g., processor 1604, or any one or more of its circuits 1620, 1621, 1622, 1623, 1624, 1625) of the processing system 1602. The instructions may be a part of various software programs and/or software modules. The computer-readable medium 1606 may include positioning instructions 1640, power instructions 1641, wireless node/sensor instructions 1642, extension instructions 1643, mapping instructions 1644, antenna orientation instructions 1645, and/or other instructions (not shown). Generally, the positioning instructions 1640, the power instructions 1641, the wireless node/sensor instructions 1642, the extension instructions 1643, mapping instructions 1644, antenna orientation instructions 1645, and/or the other instructions (not shown) may, individually or collectively, be configured for performing and/or enabling any one or more of the functions, methods, operations, processes, features and/or aspects described herein with reference to an apparatus.

The positioning instructions 1640 may include computer-executable instructions configured for positioning an apparatus in proximity to the POI and/or determining whether the apparatus is in proximity to a first wireless node of one or more wireless nodes. In some configurations, the positioning instructions 1640 may include computer-executable instructions configured for positioning the apparatus in proximity to a sensor located at the POI. In some configurations, the positioning instructions 1640 may include computer-executable instructions configured for determining whether the apparatus is in proximity to a first wireless node of the one or more wireless nodes. Such determinations may be performed according to various technologies, as described in greater detail above. In some configurations, the positioning instructions 1640 may include computer-executable instructions configured for at least partially submerging a sensor below ground. The power instructions 1641 may include computer-executable instructions configured for providing power to a wireless node and/or sensor via the extension portion of the apparatus and/or via a wireless connection from the apparatus to a wireless node. In some configurations, the power is provided to the wireless node (and/or a sensor of the wireless node) via a wired connection and/or a wireless connection according to various parameters, as described in greater detail above. The wireless node/sensor instructions 1642 may include computer-executable instructions configured for receiving data from the wireless node (and/or sensor of the wireless node) wirelessly and/or via the extension portion of the apparatus. Such reception may be performed utilizing the transceiver 1610. In some configurations, the data may be received from the wireless node (and/or sensor of the wireless node) via the extension portion of the apparatus utilizing a wired connection and/or a wireless connection according to various parameters, as described in greater detail above. The extension instructions 1643 may include computer-executable instructions configured for extending, moving, and/or retracting the extension portion of the apparatus in accordance with various aspects of the present disclosure. In some configurations, the extension instructions 1643 may include computer-executable instructions configured for moving the extension portion of the apparatus further towards the POI after positioning the apparatus in proximity to the POI. In some configurations, the extension instructions 1643 may include computer-executable instructions configured for utilizing an attractant (e.g., a magnet) to form a wired connection between the extension portion of the apparatus and the sensor. In some configurations, the extension instructions 1643 may include computer-executable instructions configured for retracting the extension portion of the apparatus after receiving the data from the sensor or after expiration of a time period during which no data is received from the sensor.

The mapping instructions 1644 may include computer-executable instructions configured for mapping, by the apparatus, a space including one or more locations of one or more wireless nodes. In some implementations, the mapping may be performed by the apparatus flying in a pattern within the space to identify landmarks within the space, the landmarks including the one or more wireless nodes. The antenna orientation instructions 1645 may include computer-executable instructions configured for determining an orientation of an antenna of a first wireless node of the one or more wireless nodes with respect to an antenna of the apparatus. In some implementations, determining the orientation of the antenna of the first wireless node may be performed using at least one of optical recognition, laser scanning, simultaneous localization and mapping (SLAM), radio frequency angle of arrival, or power measurement of the antenna of the first wireless node. The antenna orientation instructions 1645 may additionally include computer-executable instructions configured for, in response to determining that the apparatus is in proximity to the first wireless node and determining the orientation of the antenna of the first wireless node, adjusting a six-degree-of-freedom (6DoF) orientation of the apparatus based on the determined orientation of the antenna of the first wireless node. Adjusting the 6DoF orientation of the apparatus based on the determined orientation of the antenna of the first wireless node may increase the amount of power being transferred from the apparatus to the wireless node by increasing the gain (e.g., maximizing the gain) of the antenna of the apparatus.

The foregoing description provides a non-limiting example of the computer-readable medium 1606 of the processing system 1602. Although various computer-executable instructions (e.g., computer-executable code) have been described above, one of ordinary skill in the art will understand that the computer-readable medium 1606 may also include various other instructions (not shown) that are in addition and/or alternative(s) to instructions 1640, 1641, 1642, 1643, 1644, 1645 described above. Such other instructions (not shown) may include computer-executable instructions configured for performing any one or more of the functions, methods, processes, operations, features and/or aspects described herein with reference to an apparatus.

The memory 1614 may include various memory modules. The memory modules may be configured to store, and have read therefrom, various values and/or information by the processor 1604, or any of its circuits 1620, 1621, 1622, 1623, 1624, 1625. The memory modules may also be configured to store, and have read therefrom, various values and/or information upon execution of the computer-executable code included in the computer-readable medium 1606, or any of its instructions 1640, 1641, 1642, 1643, 1644, 1645. In some configurations, the memory 1614 may include location data 1630. The location data 1630 may include coordinates, positioning information, and/or other suitable data that can be used by the processor 1604 (or, specifically, the positioning circuit 1620) and/or the computer-readable medium 1606 (or, specifically, the positioning instructions 1640) to position the apparatus (e.g., apparatus 102, 402) in proximity to the POI (e.g., the wireless node 122, 822, 823, 1422, the location 422). The memory 1614 may also include wireless node data 1632. Wireless node data 1632 may include decoding, demodulation, processing parameters, and/or other suitable data that can be used by the processor 1604 (or, specifically, the wireless node/sensor circuit 1622) and/or the computer-readable medium 1606 (or, specifically, the wireless node/sensor instructions 1642) to receive and subsequently process the data from one or more wireless nodes (e.g., wireless node(s) 121-123, 141, 822, 823, 1422).

One of ordinary skill in the art will also understand that the processing system 1602 may include alternative and/or additional elements without deviating from the scope of the present disclosure. In accordance with some aspects of the present disclosure, an element, or any portion of an element, or any combination of elements may be implemented with a processing system 1602 that includes one or more processors 1604. Examples of the one or more processors 1604 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. The processing system 1602 may be implemented with a bus architecture, represented generally by the bus 1603 and bus interface 1608. The bus 1603 may include any number of interconnecting buses and bridges depending on the specific application of the processing system 1602 and the overall design constraints. The bus 1603 may link together various circuits including the one or more processors 1604, the memory 1614, and the computer-readable medium 1606. The bus 1603 may also link various other circuits, such as timing sources, peripherals, voltage regulators, and power management circuits, which are well known in the art.

The one or more processors 1604 may be responsible for managing the bus 1603 and general processing, including the execution of software stored on the computer-readable medium 1606. The software, when executed by the one or more processors 1604, causes the processing system 1602 to perform the various functions described below for any one or more apparatus. The computer-readable medium 1606 may also be used for storing data that is manipulated by the one or more processors 1604 when executing software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 1606. The computer-readable medium 1606 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1606 may also include, by way of example, a carrier wave, a transmission line, and any other suitable medium for transmitting software and/or instructions that may be accessed and read by a computer. The computer-readable medium 1606 may reside in the processing system 1602, external to the processing system 1602, or distributed across multiple entities including the processing system 1602. The computer-readable medium 1606 may be embodied in a computer program product. By way of example and not limitation, a computer program product may include a computer-readable medium in packaging materials. Those skilled in the art will recognize how best to implement the described functionality presented throughout this disclosure depending on the particular application and the overall design constraints imposed on the overall system.

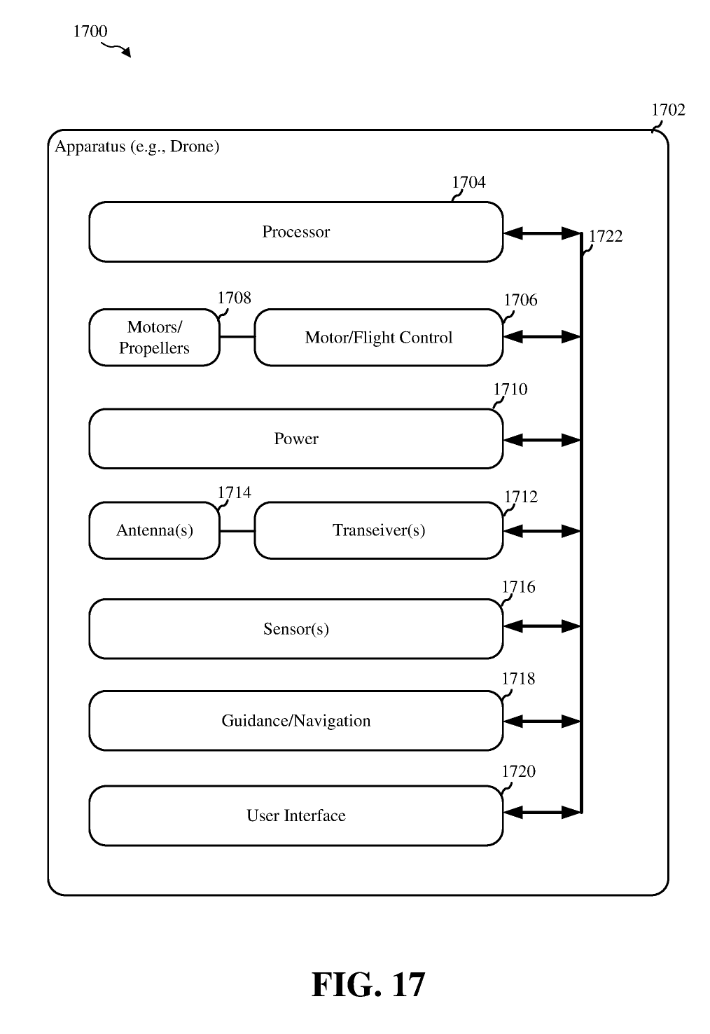

FIG. 17 is a logical device diagram 1700 illustrating an example of an interface between a processor 1704 and subsystems of an apparatus 1702. Such an apparatus 1702 may be a drone. A drone may be a multi-propeller aerial vehicle. The drone may be autonomous or semi-autonomous. Such an apparatus 1702 may be the same as or different from the apparatus 102, 402, 802 described above with reference to FIGS. 1-15 without deviating from the scope of the present disclosure. In some configurations, the apparatus 1702 may include a processor 1704. In some configurations, the processor 1704 may be similar to the processor 1604 described above with respect to FIG. 16.

The processor 1702 may interface with a motor/flight control circuit 1706. The motor/flight control circuit 1706 may control a plurality of motors 1708. Each of the plurality of motors 1708 may be coupled to its own propeller. In some configurations, each of the plurality of motors 1708 may be controlled individually such that the speed and direction of rotation of each motor may be controlled independently of the other motors. In one example, when the apparatus 1702 has eight or more motors (and therefore eight or more propellers), individual control of each of the plurality of motors 1708 provides the apparatus 1702 with an ability to maneuver in six degrees of freedom while maintaining a hover at a given point in space.

The processor 1704 may interface with a power circuit 1710. The power circuit 1710 may be the same or similar to the power circuit 1621 described in relation to FIG. 16. The power circuit 1710 may be configured to provide power to a wireless node that may include a sensor. Power may be provided via the extension portion of the apparatus and/or via an antenna of the apparatus. In some configurations, the power circuit 1710 may be configured to provide the power to the wireless node that may include the sensor via a wired connection and/or a wireless connection according to various parameters, as described in greater detail above. Accordingly, the power circuit 1710 may provide the means for providing power to the first wireless node by transmitting a signal to the antenna of the first wireless node from an antenna of the apparatus 1702 in accordance with various aspects of the disclosure described herein.

The processor 1704 may interface with a transceiver 1712. The transceiver 1712 may in turn interface with an antenna 1714. The transceiver 1712 may comprise a receiver (not shown) for receiving signals from the antenna 1714. The transceiver 1712 may comprise a transmitter (not shown) for transmitting signals to the antenna 1714. The signals received and transmitted by the transceiver 1712 may include data being received from and/or transmitted to a wireless node (such as wireless node 822, FIG. 8). Additionally or alternatively, a transceiver 1712 may supply a signal, via the antenna 1714, used to power the wireless node. A plurality of transceivers and a corresponding plurality of antennas may be accommodated by the apparatus 1702. In one configuration, the antenna 1714 comprises a plurality of symmetrically placed antennas, equally distant from a center of the drone (apparatus 1702) and at equal radial angles from each other.

The processor 1704 may interface with a sensor 1716. The sensor 1716 may include an optical sensor. An optical sensor may include one-dimensional (single beam) or 2D-(sweeping) laser rangefinders, 3D High Definition LIDAR, 3D Flash LIDAR, 2D or 3D sonar sensors and one or more 2D cameras. The sensor 1716 may be used to determine an orientation of a wireless node or of an antenna of the wireless node. The sensor may be used in conjunction with a SLAM process.

The processor 1704 may interface with a guidance/navigation package 1718 (e.g., guidance package 814, FIG. 8). The guidance/navigation package 1718 may include a Global Positioning System (GPS), a Global Information System (GIS), a satellite system, a signal triangulation system, an inertial navigation unit, a simultaneous location and mapping (SLAM) unit, a real time kinematic (RTK) unit, and/or various other suitable positioning and/or geolocation systems. The guidance/navigation package 1718 may include a range measurement device, such as a sonar device, a radar device, a vision device (e.g., a camera), a laser scanner device, and/or a laser range finder device. The range measurements device(s) and features of the guidance/navigation package 1718 may be useful for mapping the environment surrounding the apparatus 1702 as the apparatus 1702 moves through space in the vicinity of the one or more wireless nodes (e.g., wireless node 822, FIG. 8). The guidance/navigation package 1718 may be useful for guiding/navigating the apparatus 1702 to the vicinity of the one or more wireless nodes prior to a beginning of mapping operations.

The processor 1704 may interface with a user interface 1720. The user interface 1720 may be configured to receive one or more inputs from a user of the processor 1704. The user interface 1720 may also be configured to display information to the user of the processor 1702. The user interface 1720 and/or all subsystems of the apparatus 1702 may exchange data to and/or from the processor 1704 via a bus interface 1722.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

The previous description is provided to enable any person skilled in the art to practice some aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. Additionally, a phrase referring to “a, b, c, or a combination thereof” is intended to cover: a; b; c; a and b; a and c; b and c; and a, b and c. All structural and functional equivalents to the elements of some aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1. A method operational by an apparatus, the method comprising:
mapping, by the apparatus, a space including one or more locations of one or more wireless nodes;
establishing a mapped location of a first wireless node of the one or more wireless nodes based on the mapping;
hovering at a location in proximity to the mapped location of the first wireless node;
determining an orientation of an antenna of the first wireless node with respect to an antenna of the apparatus; and
in response to determining the orientation of the antenna of the first wireless node, adjusting a six-degree-of-freedom (6DoF) orientation of the apparatus to align the antenna of the apparatus with the antenna of the first wireless node, while maintaining a hover at the location.

2. The method of claim 1, wherein the apparatus is a drone, wherein the drone is a multi-propeller aerial vehicle.

3. The method of claim 1, wherein the antenna of the apparatus is a plurality of antennas and wherein the determining the orientation of the antenna of the first wireless node with respect to the antenna of the apparatus comprises comparing measurements of at least one signal received at each of the plurality of antennas to determine the orientation of the antenna of the first wireless node with respect to the antenna of the apparatus.

4. The method of claim 1, wherein the determining the orientation of the antenna of the first wireless node further comprises using optical recognition, laser scanning, simultaneous localization and mapping (SLAM), radio frequency angle of arrival, or power measurement of the antenna of the first wireless node or a combination thereof.

5. The method of claim 1, wherein the antenna of the apparatus is fixed to the apparatus and the adjusting the six-degree-of-freedom (6DoF) orientation of the apparatus, based on the orientation of the antenna of the first wireless node, further comprises orienting the apparatus in yaw, pitch, or roll or a combination thereof, while maintaining the hover at the location, to increase a directional antenna gain of the antenna of the apparatus with respect to the orientation of the antenna of the first wireless node.

6. The method of claim 5, wherein the apparatus is a multi-propeller aerial vehicle, and the adjusting the six-degree-of-freedom (6DoF) orientation of the apparatus further comprises tilting propellers of the apparatus relative to a body of the apparatus.

7. The method of claim 5, wherein the adjusting the six-degree-of-freedom (6DoF) orientation of the apparatus comprises aligning an angle of maximum gain of the antenna of the apparatus with an angle of maximum gain of the antenna of the first wireless node based on the determined orientation of the antenna of the first wireless node, and further comprises translating a position of the apparatus in an X, Y, and Z direction toward the antenna of the first wireless node while avoiding obstacles adjacent to the first wireless node.

8. The method of claim 1, further comprising:
providing power to the first wireless node by transmitting a signal to the antenna of the first wireless node from the antenna of the apparatus.

9. The method of claim 1, further comprising:
receiving data from the first wireless node by receiving a signal from the antenna of the first wireless node at the antenna of the apparatus.

10. The method of claim 1, further comprising:
moving to a second wireless node after receiving data from the first wireless node or after expiration of a time period during which no data is received from the first wireless node.

11. A drone, comprising:
a plurality of motorized propellers;
an antenna;
a sensor;
a transceiver coupled to the antenna;
a memory; and
at least one processor communicatively coupled to the plurality of motorized propellers, the antenna, the sensor, the transceiver, and the memory, wherein the at least one processor is configured to:
map a space including one or more locations of one or more wireless nodes using the sensor;
establish a mapped location of a first wireless node of the one or more wireless nodes based on the map;
hover at a location in proximity to the mapped location of the first wireless node;
determine an orientation of an antenna of the first wireless node with respect to the antenna of the drone; and
in response to determining the orientation of the antenna of the first wireless node, adjust a six-degree-of-freedom (6DoF) orientation of the drone, using the plurality of motorized propellers, to align the antenna of the drone with the antenna of the first wireless node, while maintaining the hover at the location.

12. The drone of claim 11, wherein the antenna of the drone is a plurality of antennas and wherein the processor is further configured to determine the orientation of the antenna of the first wireless node with respect to the antenna of the drone by comparing measurements of at least one signal received at each of the plurality of antennas to determine the orientation of the antenna of the first wireless node with respect to the antenna of the drone.

13. The drone of claim 11, wherein the processor is further configured to determine the orientation of the antenna of the first wireless node by using optical recognition, laser scanning, simultaneous localization and mapping (SLAM), radio frequency angle of arrival, or power measurement of the antenna of the first wireless node, or a combination thereof.

14. The drone of claim 11, wherein the antenna comprises a plurality of symmetrically placed antennas, equally distant from a center of the drone and at equal radial angles from each other, wherein the processor is further configured to determine whether the drone is in proximity to the first wireless node of the one or more wireless nodes and determine the orientation of the antenna of the first wireless node using a comparison of measurements of at least one signal received at each of the plurality of symmetrically placed antennas.

15. The drone of claim 11, wherein the antenna of the drone is fixed to the drone and the processor is further configured to adjust the six-degree-of-freedom (6DoF) orientation of the drone, based on the orientation of the antenna of the first wireless node, by orienting the drone in yaw, pitch, or roll, or a combination thereof, while maintaining the hover at the location, to increase a directional antenna gain of the antenna of the drone with respect to the orientation of the antenna of the first wireless node.

16. The drone of claim 15, wherein the drone is a multi-propeller aerial vehicle and the processor is further configured to adjust the six-degree-of-freedom (6DoF) orientation of the drone by tilting propellers of the drone relative to a body of the drone.

17. The drone of claim 15, wherein the adjust the six-degree-of-freedom (6DoF) orientation of the drone is accomplished by aligning an angle of maximum gain of the antenna of the drone with an angle of maximum gain of the antenna of the first wireless node based on the determined orientation of the antenna of the first wireless node, and the processor is further configured to translate a position of the drone in an X, Y, and Z direction toward the antenna of the first wireless node while avoiding obstacles adjacent to the first wireless node.

18. The drone of claim 11, wherein the processor is further configured to:
provide power to the first wireless node by transmitting a signal to the antenna of the first wireless node from the antenna of the drone.

19. The drone of claim 11, wherein the processor is further configured to:
receive data from the first wireless node by receiving a signal from the antenna of the first wireless node at the antenna of the drone.

20. The drone of claim 11, wherein the processor is further configured to:
move to a second wireless node after receiving data from the first wireless node or after expiration of a time period during which no data is received from the first wireless node.

21. An drone, comprising:
means for mapping, by the drone, a space including one or more locations of one or more wireless nodes;
means for establishing a mapped location of a first wireless node of the one or more wireless nodes based on the mapping;
means for hovering at a location in proximity to the mapped location of the first wireless node;
means for determining an orientation of an antenna of the first wireless node with respect to an antenna of the drone; and
means for, in response to determining the orientation of the antenna of the first wireless node, adjusting a six-degree-of-freedom (6DoF) orientation of the drone to align the antenna of the drone with the antenna of the first wireless node, while maintaining the hovering at the location.

22. The drone of claim 21, wherein the antenna of the drone is a plurality of antennas and wherein the means for determining the orientation of the antenna of the first wireless node with respect to the antenna of the drone compares measurements of at least one signal received at each of the plurality of antennas to determine the orientation of the antenna of the first wireless node with respect to the antenna of the drone.

23. The drone of claim 21, wherein the means for determining the orientation of the antenna of the first wireless node is configured to use optical recognition, laser scanning, simultaneous localization and mapping (SLAM), radio frequency angle of arrival, or power measurement of the antenna of the first wireless node, or a combination thereof.

24. The drone of claim 21, wherein the means for determining whether the drone is in proximity to the first wireless node of the one or more wireless nodes and means for determining the orientation of the antenna of the first wireless node comprises a plurality of symmetrically placed antennas, equally distant from a center of the drone and at equal radial angles from each other and are configured to use a comparison of measurements of at least one signal received at each of the plurality of symmetrically placed antennas.

25. The drone of claim 21, wherein the antenna of the drone is fixed to the drone and means for adjusting the six-degree-of-freedom (6DoF) orientation of the drone, based on the orientation of the antenna of the first wireless node, comprises means for orienting the drone in yaw, pitch, or roll, or a combination thereof, while maintaining the hovering at the location, to increase a directional antenna gain of the antenna of the drone with respect to the orientation of the antenna of the first wireless node.

26. The drone of claim 25, wherein the drone is a multi-propeller aerial vehicle and the means for adjusting the six-degree-of-freedom (6DoF) orientation of the drone comprises means for tilting propellers of the drone relative to a body of the drone.

27. The drone of claim 25, wherein the means for adjusting the six-degree-of-freedom (6DoF) orientation of the drone aligns an angle of maximum gain of the antenna of the drone with an angle of maximum gain of the antenna of the first wireless node based on the determined orientation of the antenna of the first wireless node and further comprises means for translating a position of the drone in an X, Y, and Z direction toward the antenna of the first wireless node while avoiding obstacles adjacent to the first wireless node.

28. The drone of claim 21, further comprising:
means for providing power to the first wireless node by transmitting a signal to the antenna of the first wireless node from the antenna of the drone.

29. The drone of claim 21, further comprising:
means for receiving data from the first wireless node by receiving a signal from the antenna of the first wireless node at the antenna of the drone.

30. The drone of claim 21, further comprising:
means for moving to a second wireless node after receiving data from the first wireless node or after expiration of a time period during which no data is received from the first wireless node.
